(19) United States
(12) Patent Application Publication
(10) Pub. No.: US 2026/0051993 A1
(43) Pub. Date: Feb. 19, 2026

(54) UPLINK TRANSMISSION AND SOUNDING REFERENCE SIGNAL CARRIER SWITCHING

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/806,250

(22) Filed: Aug. 15, 2024

(51) Int. Cl. H04L 5/00; H04W 72/1268; H04W 72/231; H04W 72/51

(52) U.S. Cl. CPC H04L 5/0051; H04L 5/0096; H04W 72/1268; H04W 72/231; H04W 72/51

(57) ABSTRACT

Various aspects of the present disclosure generally relate to wireless communication. In some aspects, a wireless network may enable sequential sounding reference signal (SRS) carrier switching and may enable coordination between uplink (UL) transmission (TX) switching and SRS carrier switching, resulting in improved network performance and reduced downlink (DL) and/or UL interruptions. Additionally, a network node may indicate an updated selected sequential SRS carrier switching pattern, wherein the updated selection may be based on changed network performance parameters and/or measurements.

### FIELD OF THE DISCLOSURE

Aspects of the present disclosure generally relate to wireless communication and specifically relate to techniques, apparatuses, and methods associated with uplink transmission and sounding reference signal carrier switching.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In a wireless network, a sounding reference signal (SRS) is an uplink reference signal that a user equipment (UE) transmits to a network node. For example, an SRS may carry information used for uplink channel estimation, which the network node may use for scheduling, link adaptation, precoder selection, and/or beam management, among other examples. The network node may configure one or more SRS resource sets for the UE, and the UE may transmit SRSs on the configured SRS resource sets. An SRS resource set may have a configured usage, such as uplink (UL) channel state information (CSI) acquisition, downlink (DL) CSI acquisition for reciprocity-enabled operations, and/or uplink beam management, among other examples. The network node may measure the SRSs, may perform channel estimation according at least in part to the measurements, and may use the SRS measurements to configure communications with the UE.

SRS transmissions may be utilized in carrier aggregation configurations to enable channel quality estimation for multiple cells, including enabling UL channel quality optimization. Additionally, a network node can utilize channel quality estimation results from SRS transmission in the context of UL scheduling and/or DL scheduling. However, SRS transmissions may pose challenges for DL-only secondary cells (Scells) because an SRS transmission is an UL signal and DL-only Scells lack UL resources (for example, physical uplink control channel (PUCCH) and/or physical uplink shared channel (PUSCH) resources) for transmitting an SRS.

SRS carrier switching enables SRS transmissions to DL-only Scells in accordance with the capabilities of a UE (for example, SRS carrier switching, SRS antenna switching with a supported band comb, or other suitable capabilities). In this way, SRS carrier switching improves the downlink MIMO performance in DL-only Scells. In such examples, however, each SRS carrier switch is performed between a single primary cell (Pcell) and a DL-only Scell (for example, between the Pcell and a first Scell, the Pcell and a second Scell, the Pcell and a third Scell, and so on). As a result of this operation, every SRS carrier switch results in an interruption of DL and/or UL data transmissions, with such interruptions depending on the capability of the UE on different band combinations.

Furthermore, in some cases, UL TX switching and SRS carrier switching may be performed in a carrier aggregation configuration that includes one or more DL-only Scells and one or more Scells with an uplink configuration (for example, a DL/UL Scell or an UL-only Scell). For example, UL TX switching may be performed to switch a TX chain from a source carrier to a target carrier such that the TX chain can be used to transmit an SRS or uplink data on the target carrier (for example, when uplink resources are configured for the UE on the source carrier and the target carrier). Alternatively, SRS carrier switching may be performed to switch a TX chain to or from a DL-only Scell (for example, prior to or following an SRS transmission on the DL-only Scell). However, wireless networks generally lack support for coordinating UL TX switching and SRS carrier switching. For example, UL TX switching and SRS carrier switching always use a Pcell as a pivot point (for example, the Pcell is always either the source carrier or the target carrier in an UL TX switch or an SRS carrier switch). As a result, the UE may experience degraded performance and efficiency (for example, always using the Pcell as a pivot point may delay SRS transmission on a DL-only Scell, resulting in the DL-only Scell using a potentially outdated channel estimate, may delay UL data transmissions, and/or may limit the number of layers utilized for UL transmission).

### SUMMARY

Some aspects described herein relate to a user equipment (UE) for wireless communication. The UE may include a processing system that includes one or more processors and one or more memories coupled with the one or more processors. The processing system may be configured to cause the UE to receive an indication of a sounding reference signal (SRS) carrier switching pattern. The processing system may be configured to cause the UE to perform SRS carrier switching between a plurality of carriers, wherein performing the SRS carrier switching includes sequentially transmitting an SRS to a plurality of cells associated with the plurality of carriers according to the SRS carrier switching pattern.

Some aspects described herein relate to a UE for wireless communication. The UE may include a processing system that includes one or more processors and one or more memories coupled with the one or more processors. The processing system may be configured to cause the UE to receive an indicator for coordinating uplink (UL) transmission (TX) switching and SRS carrier switching. The processing system may be configured to cause the UE to switch at least one TX chain from a source carrier to a target carrier according to the indicator, wherein the source carrier is a source UL carrier or a source SRS carrier. The processing system may be configured to cause the UE to transmit one or more UL signals on the target carrier using the at least one TX chain, wherein the one or more uplink signals include one or more of an SRS or a physical uplink shared channel (PUSCH) communication.

Some aspects described herein relate to a network node for wireless communication. The network node may include a processing system that includes one or more processors and one or more memories coupled with the one or more processors. The processing system may be configured to cause the network node to transmit, to a UE, an indication of an SRS carrier switching pattern. The processing system may be configured to cause the network node to receive, from the UE, an SRS at a plurality of cells associated with a plurality of carriers in a sequence associated with the SRS carrier switching pattern.

Some aspects described herein relate to a network node for wireless communication. The network node may include a processing system that includes one or more processors and one or more memories coupled with the one or more processors. The processing system may be configured to cause the network node to transmit, to a UE, an indicator for coordinating UL TX switching and SRS carrier switching, wherein the indicator enables the UE to switch at least one TX chain from a source carrier to a target carrier, wherein the source carrier is a source UL carrier or a source SRS carrier. The processing system may be configured to cause the network node to receive, from the UE, one or more uplink signals on the target carrier, wherein the one or more uplink signals include one or more of an SRS or a PUSCH communication.

Some aspects described herein relate to a method for wireless communication by a UE. The method may include receiving an indication of an SRS carrier switching pattern. The method may include performing SRS carrier switching between a plurality of carriers, wherein performing the SRS carrier switching includes sequentially transmitting an SRS to a plurality of cells associated with the plurality of carriers according to the SRS carrier switching pattern.

Some aspects described herein relate to a method for wireless communication by a UE. The method may include receiving an indicator for coordinating UL TX switching and SRS carrier switching. The method may include switching at least one TX chain from a source carrier to a target carrier according to the indicator, wherein the source carrier is a source UL carrier or a source SRS carrier. The method may include transmitting one or more uplink signals on the target carrier using the at least one TX chain, wherein the one or more uplink signals include one or more of an SRS or a PUSCH communication.

Some aspects described herein relate to a method for wireless communication by a network node. The method may include transmitting, to a UE, an indication of an SRS carrier switching pattern. The method may include receiving, from the UE, an SRS at a plurality of cells associated with a plurality of carriers in a sequence associated with the SRS carrier switching pattern.

Some aspects described herein relate to a method of wireless communication performed by a network node. The method may include transmitting, to a UE, an indicator for coordinating UL TX switching and SRS carrier switching, wherein the indicator enables the UE to switch at least one TX chain from a source carrier to a target carrier, wherein the source carrier is a source UL carrier or a source SRS carrier. The method may include receiving, from the UE, one or more uplink signals on the target carrier, wherein the one or more uplink signals include one or more of an SRS or a PUSCH communication.

Some aspects described herein relate to a non-transitory computer-readable medium that stores a set of instructions for wireless communication by a UE. The set of instructions, when executed by one or more processors of the UE, may cause the UE to receive an indication of an SRS carrier switching pattern. The set of instructions, when executed by one or more processors of the UE, may cause the UE to perform SRS carrier switching between a plurality of carriers, wherein performing the SRS carrier switching includes sequentially transmitting an SRS to a plurality of cells associated with the plurality of carriers according to the SRS carrier switching pattern.

Some aspects described herein relate to a non-transitory computer-readable medium that stores a set of instructions for wireless communication by a UE. The set of instructions, when executed by one or more processors of the UE, may cause the UE to receive an indicator for coordinating UL TX switching and SRS carrier switching. The set of instructions, when executed by one or more processors of the UE, may cause the UE to switch at least one TX chain from a source carrier according to the indicator, wherein the source carrier is a source UL carrier or a source SRS carrier. The set of instructions, when executed by one or more processors of the UE, may cause the UE to transmit one or more uplink signals on the target carrier using the at least one TX chain, wherein the one or more uplink signals include one or more of an SRS or a PUSCH communication.

Some aspects described herein relate to a non-transitory computer-readable medium that stores a set of instructions for wireless communication by a network node. The set of instructions, when executed by one or more processors of the network node, may cause the network node to transmit, to a UE, an indication of an SRS carrier switching pattern. The set of instructions, when executed by one or more processors of the network node, may cause the network node to receive, from the UE, an SRS at a plurality of cells associated with a plurality of carriers in a sequence associated with the SRS carrier switching pattern.

Some aspects described herein relate to a non-transitory computer-readable medium that stores a set of instructions for wireless communication by a network node. The set of instructions, when executed by one or more processors of the network node, may cause the network node to transmit, to a UE, an indicator for coordinating UL TX switching and SRS carrier switching, wherein the indicator enables the UE to switch at least one TX chain from a source carrier to a target carrier, wherein the source carrier is a source UL carrier or a source SRS carrier. The set of instructions, when executed by one or more processors of the network node, may cause the network node to receive, from the UE, one or more uplink signals on the target carrier, wherein the one or more uplink signals include one or more of an SRS or a PUSCH communication.

Some aspects described herein relate to an apparatus for wireless communication. The apparatus may include means for receiving an indication of an SRS carrier switching pattern. The apparatus may include means for performing SRS carrier switching between a plurality of carriers, wherein performing the SRS carrier switching includes sequentially transmitting an SRS to a plurality of cells associated with the plurality of carriers according to the SRS carrier switching pattern.

Some aspects described herein relate to an apparatus for wireless communication. The apparatus may include means for receiving an indicator for coordinating UL TX switching and SRS carrier switching. The apparatus may include means for switching at least one TX chain from a source carrier to a target carrier according to the indicator, wherein the source carrier is a source UL carrier or a source SRS carrier. The apparatus may include means for transmitting one or more uplink signals on the target carrier using the at least one TX chain, wherein the one or more uplink signals include one or more of an SRS or a PUSCH communication.

Some aspects described herein relate to an apparatus for wireless communication. The apparatus may include means for transmitting, to a UE, an indication of an SRS carrier switching pattern. The apparatus may include means for receiving, from the UE, an SRS at a plurality of cells associated with a plurality of carriers in a sequence associated with the SRS carrier switching pattern.

Some aspects described herein relate to an apparatus for wireless communication. The apparatus may include means for transmitting, to a UE, an indicator for coordinating UL TX switching and SRS carrier switching, wherein the indicator enables the UE to switch at least one TX chain from a source carrier to a target carrier, wherein the source carrier is a source UL carrier or a source SRS carrier. The apparatus may include means for receiving, from the UE, one or more uplink signals on the target carrier, wherein the one or more uplink signals include one or more of an SRS or a PUSCH communication.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a transmit (TX) chain and a receive (RX) chain of a UE in accordance with the present disclosure in accordance with the present disclosure.

FIG. 5 is a diagram illustrating an example of sounding reference signal (SRS) resource sets in accordance with the present disclosure.

FIG. 6 is a diagram illustrating an example of SRS carrier switching for downlink (DL) carrier aggregation in accordance with the present disclosure.

FIG. 7 is a diagram illustrating an example of SRS carrier switching for DL carrier aggregation in accordance with the present disclosure.

FIGS. 8-9 are diagrams illustrating examples associated with sequential SRS carrier switching in accordance with the present disclosure.

FIG. 10 is a diagram illustrating an example of UL TX switching in accordance with the present disclosure.

FIGS. 11-13 are diagrams illustrating examples associated with coordination between UL TX switching and SRS carrier switching in accordance with the present disclosure.

FIG. 14 is a flowchart illustrating an example process performed, for example, at a UE or an apparatus of a UE that supports sequential SRS carrier switching in accordance with the present disclosure.

FIG. 15 is a flowchart illustrating an example process performed, for example, at a UE or an apparatus of a UE that supports coordination between UL TX switching and SRS carrier switching in accordance with the present disclosure.

FIG. 16 is a flowchart illustrating an example process performed, for example, at a network node or an apparatus of a network node that supports sequential SRS carrier switching in accordance with the present disclosure.

FIG. 17 is a flowchart illustrating an example process performed, for example, at a network node or an apparatus of a network node that supports coordination between UL TX switching and SRS carrier switching in accordance with the present disclosure.

FIGS. 18-19 are diagrams of example apparatuses for wireless communication that supports sequential SRS carrier switching and the coordination of UL TX switching and SRS carrier switching in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, carrier aggregation is a technology that enables two or more component carriers (CCs, sometimes referred to as carriers) to be combined (for example, into a single channel) for a single user equipment (UE) to enhance data capacity. Carriers can be combined in the same or different frequency bands. Additionally or alternatively, contiguous or non-contiguous carriers can be combined. A network node may configure carrier aggregation for a UE, such as in a radio resource control (RRC) message, downlink control information (DCI), and/or another signaling message.

In some examples, carrier aggregation may be configured in an intra-band contiguous mode where the aggregated carriers are contiguous to one another and are in the same band. In some other examples, carrier aggregation may be configured in an intra-band non-contiguous mode where the aggregated carriers are non-contiguous to one another and are in the same band. In some other examples, carrier aggregation may be configured in an inter-band non-contiguous mode where the aggregated carriers are non-contiguous to one another and are in different bands.

In carrier aggregation, a UE may be configured with a primary carrier or primary cell (Pcell) and one or more secondary carriers or secondary cells (Scells). The primary carrier may carry control information (for example, DCI and/or scheduling information) for scheduling data communications on one or more secondary carriers, which may be referred to as cross-carrier scheduling. In some aspects, a carrier (for example, a primary carrier or a secondary carrier) may carry control information for scheduling data communications on the carrier, which may be referred to as self-carrier scheduling or carrier self-scheduling.

A sounding reference signal (SRS) is an uplink reference signal that a UE transmits to a network node. For example, an SRS may carry information used for uplink channel estimation, which the network node may use for scheduling, link adaptation, precoder selection, and/or beam management, among other examples. The network node may configure one or more SRS resource sets for the UE, and the UE may transmit SRSs on the configured SRS resource sets. An SRS resource set may have a configured usage, such as uplink (UL) channel state information (CSI) acquisition, downlink (DL) CSI acquisition for reciprocity-enabled operations, and/or uplink beam management, among other examples. The network node may measure the SRSs, may perform channel estimation according at least in part to the measurements, and may use the SRS measurements to configure communications with the UE.

SRS transmissions may be utilized in carrier aggregation configurations to enable channel quality estimation for multiple cells, including enabling UL channel quality optimization. Additionally, a network note can utilize channel quality estimation results from SRS in the context of UL scheduling and/or DL scheduling. SRS transmissions may pose challenges for DL-only Scells where an SRS transmission is an UL signal and DL-only Scells lack UL resources (for example, physical uplink control channel (PUCCH) and/or physical uplink shared channel (PUSCH) resources) for transmitting an SRS.

SRS carrier switching enables SRS transmissions to DL-only Scells in accordance with the capabilities of a UE (for example, SRS carrier switching, SRS antenna switching with a supported band comb, or other capabilities). In this way, SRS carrier switching improves the downlink MIMO performance in DL-only Scells. In such examples, however, each SRS carrier switch is performed between a single Pcell and a DL-only Scell (for example, between the Pcell and a first Scell, the Pcell and a second Scell, the Pcell and a third Scell, and so on). As a result of this operation, every SRS carrier switch results in an interruption of DL and/or UL data transmissions, with such interruptions depending on the capability of the UE on different band combinations.

Furthermore, in some cases, UL TX switching and SRS carrier switching may be performed in a carrier aggregation configuration that includes one or more DL-only Scells and one or more Scells with an uplink configuration (for example, a DL/UL Scell or an UL-only Scell). For example, UL TX switching may be performed to switch a TX chain from a source carrier to a target carrier such that the TX chain can be used to transmit an SRS or uplink data on the source carrier (for example, when uplink resources are configured for the UE on the source carrier and the target carrier). Alternatively, SRS carrier switching may be performed to switch a TX chain to or from a DL-only Scell (for example, prior to or following an SRS transmission on the DL-only Scell). However, wireless networks generally lack support for coordinating UL TX switching and SRS carrier switching. For example, UL TX switching and SRS carrier switching always use a Pcell as a pivot point (for example, the Pcell is always either the source carrier or the target carrier in an UL TX switch or an SRS carrier switch). As a result, the UE may experience degraded performance and efficiency (for example, always using the Pcell as a pivot point may delay SRS transmission on a DL-only Scell, resulting in the DL-only Scell using a potentially outdated channel estimate, delay UL data transmissions, and/or limit the number of layers utilized for UL data transmission on the DL/UL and/or UL-only Scell.

Various aspects relate generally to sequential SRS carrier switching and to coordination between UL TX switching and SRS carrier switching. Some aspects more specifically relate to sequential SRS carrier switching according to a pattern that does not require the Pcell to be a pivot point in each SRS carrier switch (for example, an SRS carrier switch may be performed from a first DL-only Scell to a second DL-only Scell). For example, after receiving an indication that a UE supports sequential SRS carrier switching, a network node may indicate a selected sequential SRS carrier switching pattern (for example, according to performance parameters, measurements, and/or a UE preference) and the UE may transmit a series of SRSs on the Pcell and/or one or more DL-only Scells according to the SRS carrier switching pattern. Additionally, the network node may indicate an updated selected sequential SRS carrier switching pattern, which may be performed in accordance with changed network performance parameters, measurements, and/or the UE preference. Additionally, in some aspects, UL TX switching and SRS carrier switching may be coordinated from a Pcell to a DL/UL Scell and/or DL-only Scells. For example, by switching a TX chain between carriers with an uplink configuration (for example, a DL/UL Scell or an UL-only Scell), the TX chain switching may enable SRS, PUSCH, or multi-layer PUSCH on the target carrier.

Particular aspects of the subject matter described in this disclosure can be implemented to realize one or more of the following potential advantages. In some examples, the described techniques can be used to improve downlink MIMO performance in Scells, where an SRS carrier switch to a DL-only Scell enables a current channel estimation prior to a DL TX. In some other examples, the described techniques can be used to reduce DL and/or UL data interruptions during SRS carrier switching, and to improve performance including reduced network congestion (for example, by reducing uplink SRS traffic on the Pcell), improved power conservation (for example, by reducing the number of SRS transmissions to enable uplink channel estimation across all cells), and/or improved uplink data throughput (for example, by enabling multi-layer UL data TX on carriers having UL configurations).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

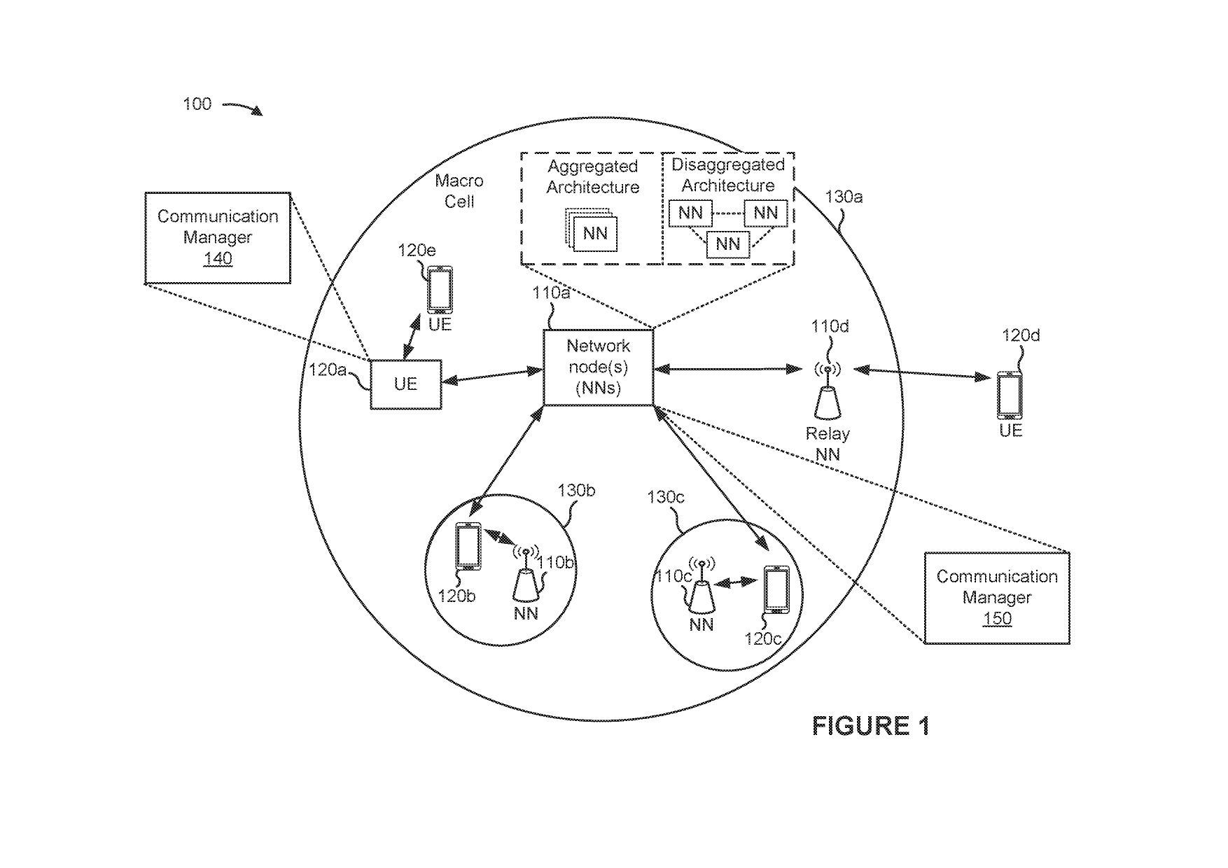

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, in accordance with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c.Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more PUSCHs. The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) according to changing network conditions in the wireless communication network 100 and/or according to the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an indication of an SRS carrier switching pattern; and perform SRS carrier switching between a plurality of carriers, wherein performing the SRS carrier switching includes sequentially transmitting an SRS to a plurality of cells associated with the plurality of carriers according to the SRS carrier switching pattern. Additionally or alternatively, the communication manager 140 may receive an indicator for coordinating UL TX switching and SRS carrier switching; switch at least one TX chain from a source carrier to a target carrier according to the indicator, wherein the source carrier is a source UL carrier or a source SRS carrier; and transmit one or more uplink signals on the target carrier using the at least one TX chain, wherein the one or more uplink signals include one or more of an SRS or a PUSCH communication. Additionally or alternatively, the communication manager 140 may perform one or more other operations described herein.

In some aspects, the network node 110 may include a communication manager 150. As described in more detail elsewhere herein, the communication manager 150 may transmit, to a UE 120, an indication of an SRS carrier switching pattern; and receive, from the UE 120, an SRS at a plurality of cells associated with a plurality of carriers in a sequence associated with the SRS carrier switching pattern. Additionally or alternatively, the communication manager 150 may transmit, to a UE 120, an indicator for coordinating UL TX switching and SRS carrier switching, wherein the indicator enables the UE 120 to switch at least one TX chain from a source carrier to a target carrier, wherein the source carrier is a source UL carrier or a source SRS carrier; and receive, from the UE 120, one or more uplink signals on the target carrier, wherein the one or more uplink signals include one or more of an SRS or a PUSCH communication. Additionally or alternatively, the communication manager 150 may perform one or more other operations described herein.

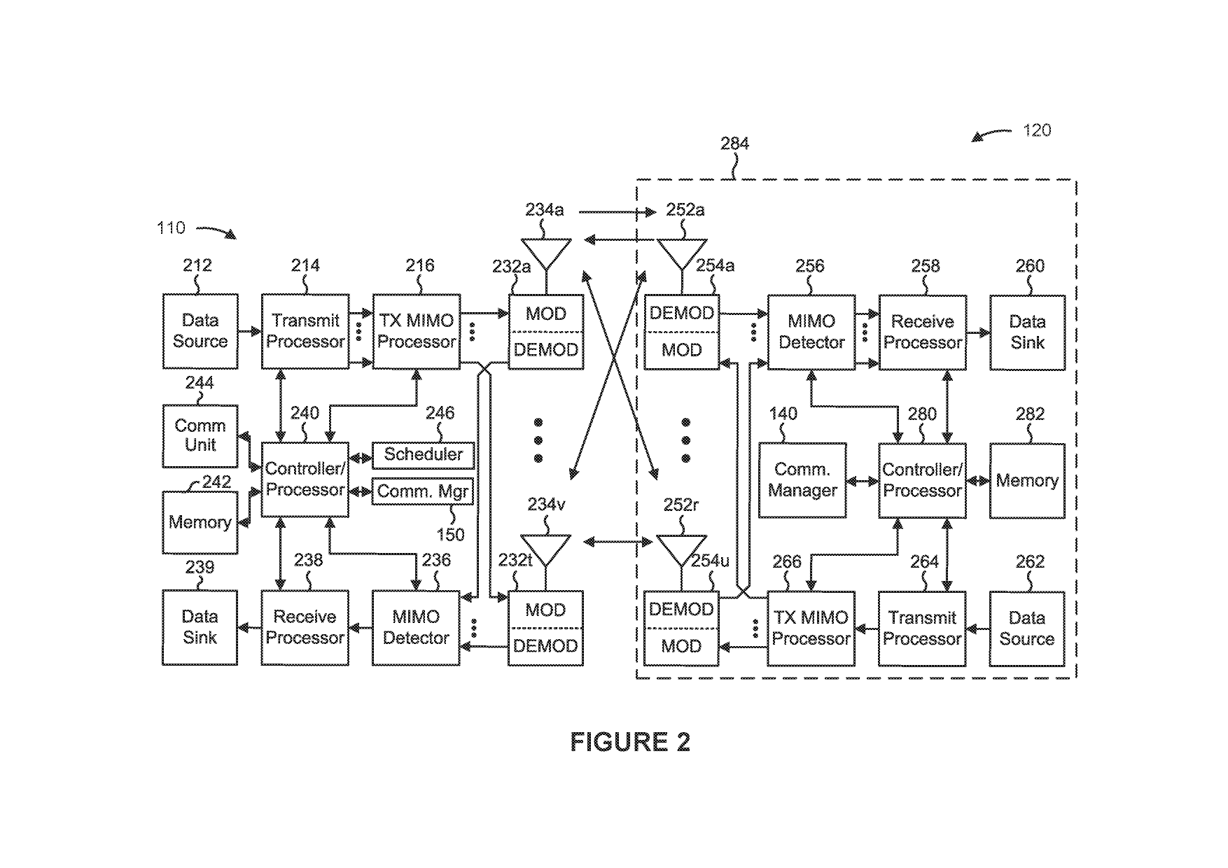

FIG. 2 is a diagram illustrating an example network node 110 in communication with an example UE 120 in a wireless network in accordance with the present disclosure.

As shown in FIG. 2, the network node 110 may include a data source 212, a transmit processor 214, a TX MIMO processor 216, a set of modems 232 (shown as 232a through 232t, where t ≥ 1), a set of antennas 234 (shown as 234a through 234v, where v ≥ 1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a machine access control-control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be in accordance with or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (RX) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r ≥ 1), a set of modems 254 (shown as modems 254a through 254u, where u ≥ 1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

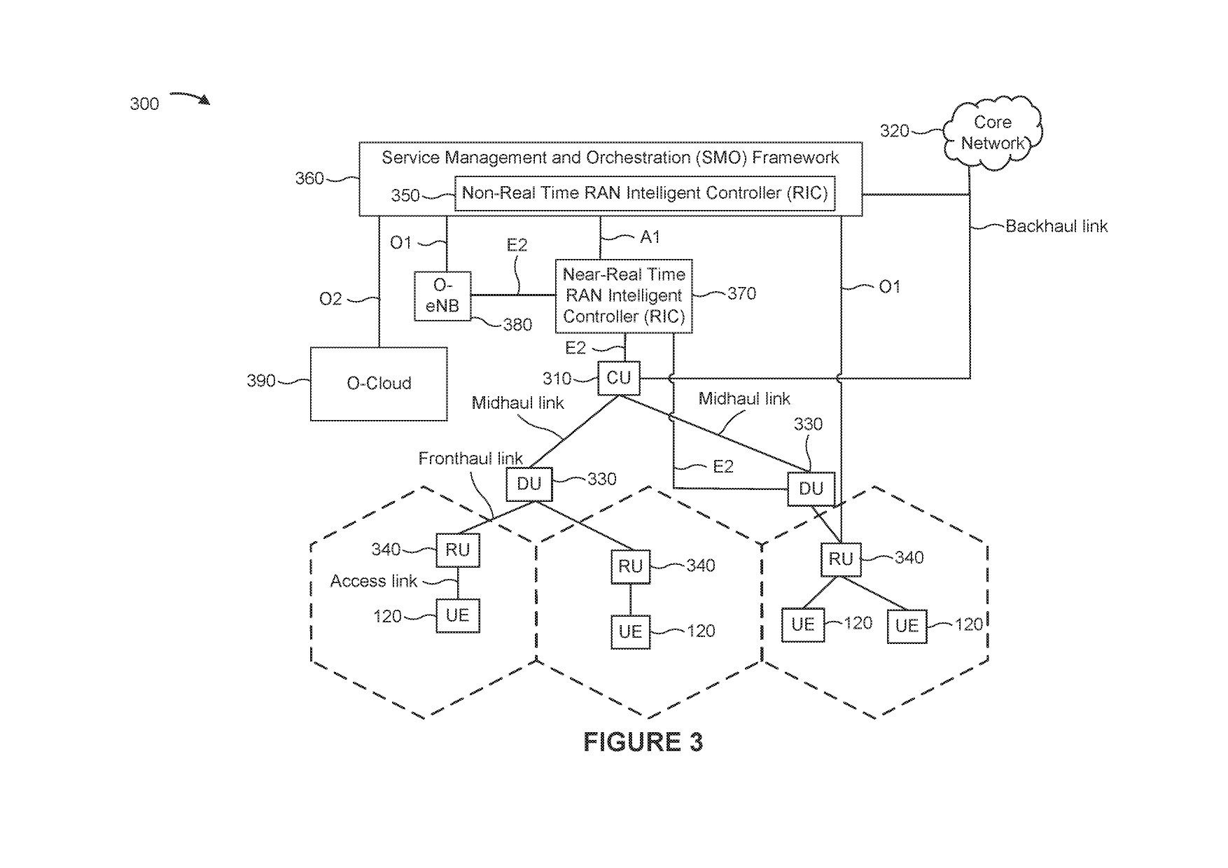

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-enabled RAN architecture, such as a vRAN architecture.

The Non-RT RIC 350 may include or may implement a logical function that enables non-real-time control and optimization of RAN elements and resources, AI/ML workflows including model training and updates, and/or policy-enabled guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

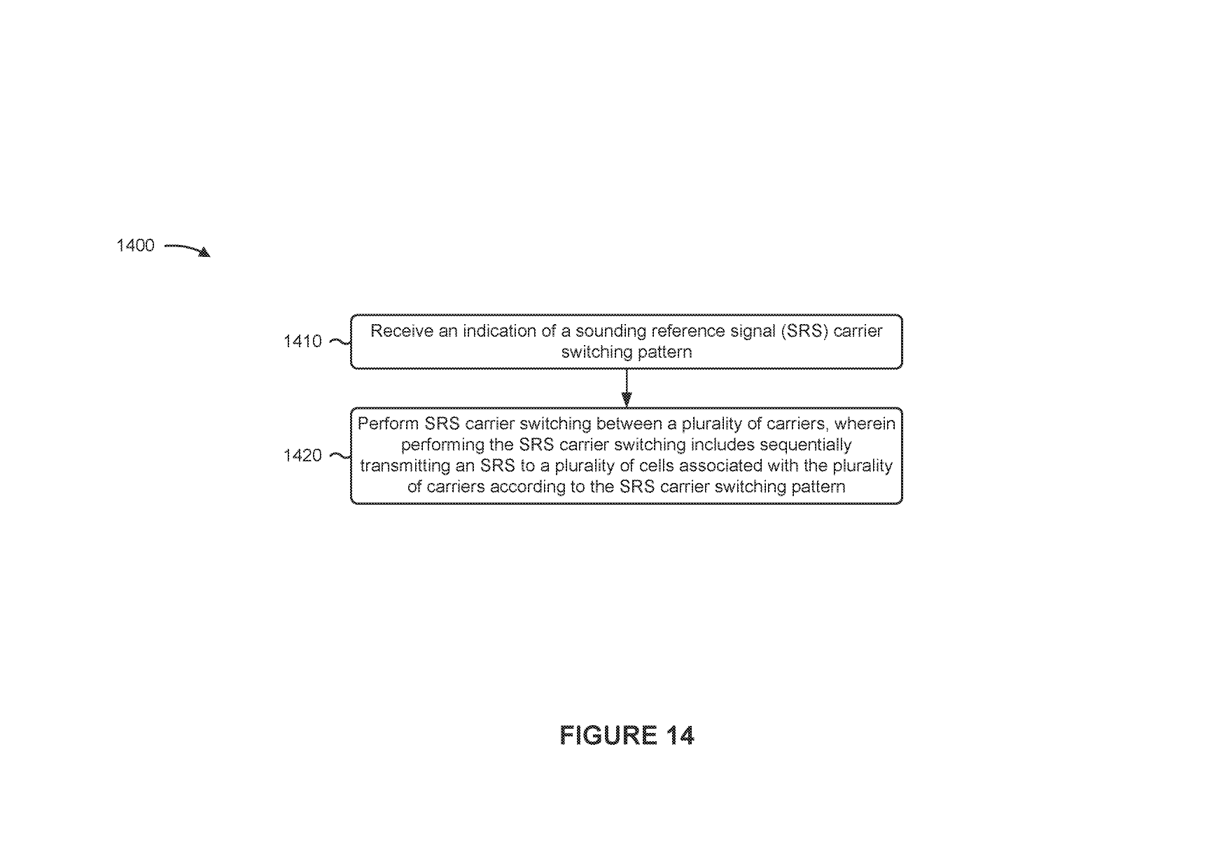

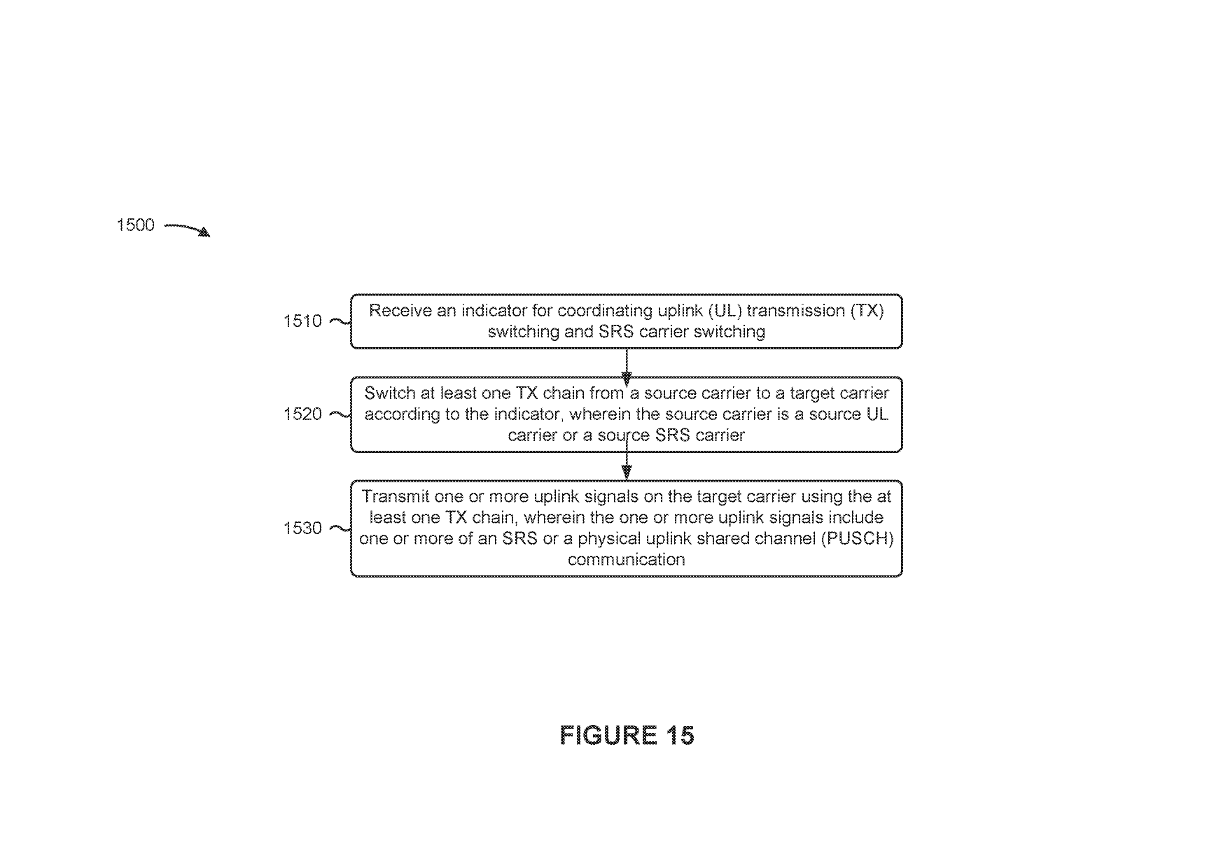

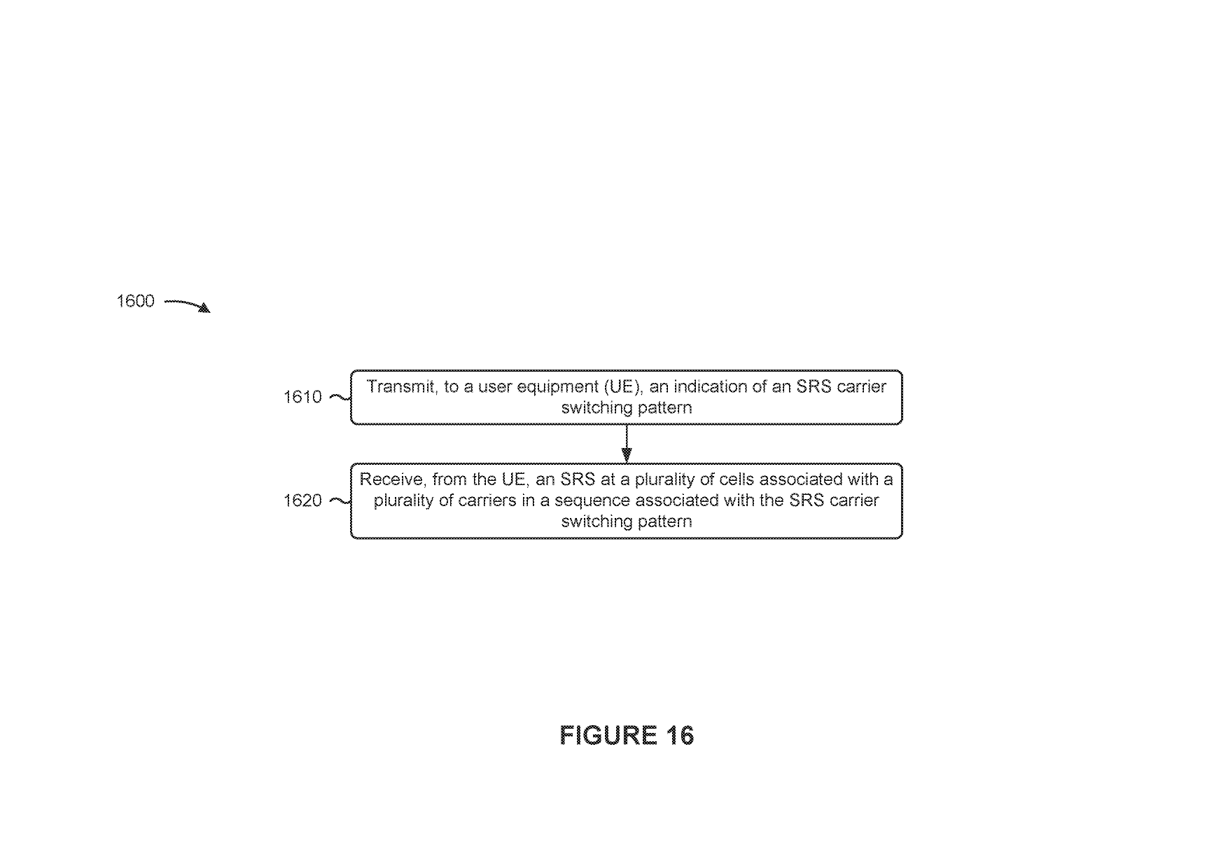

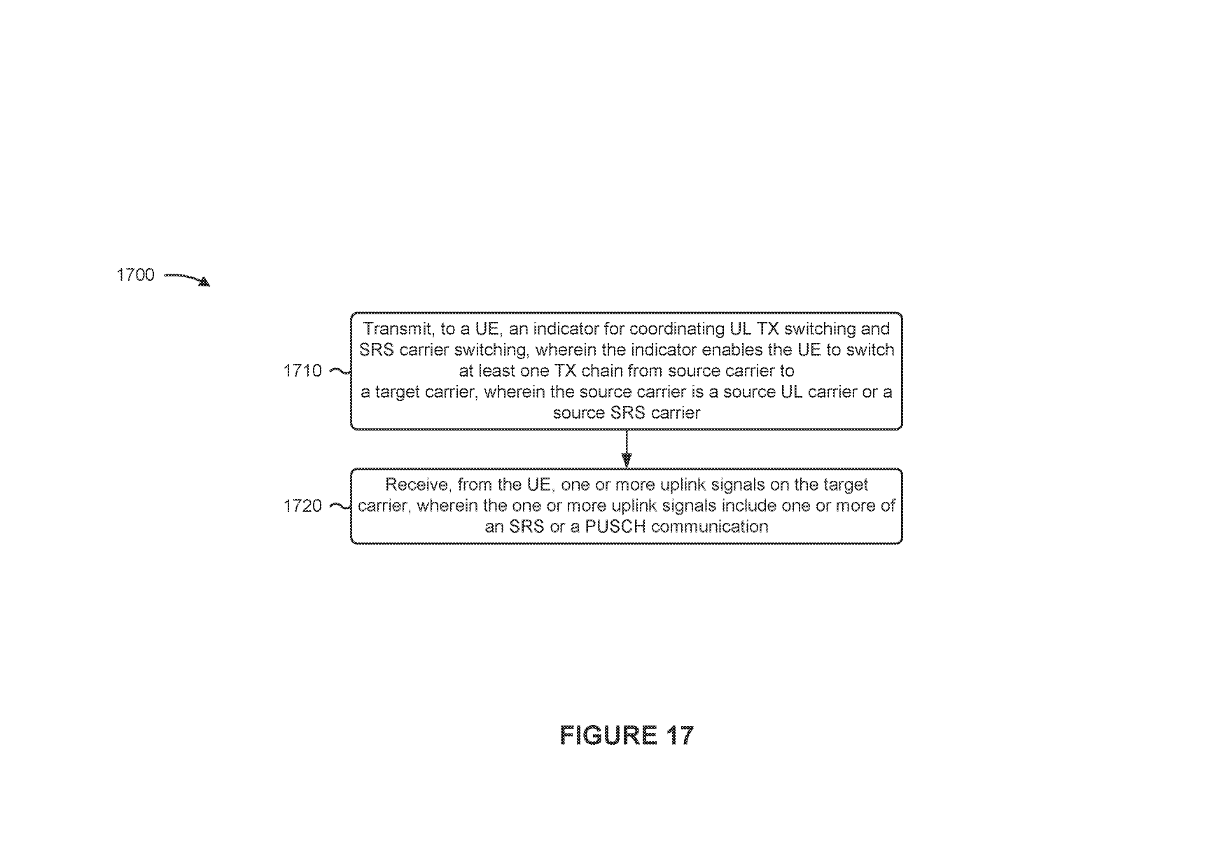

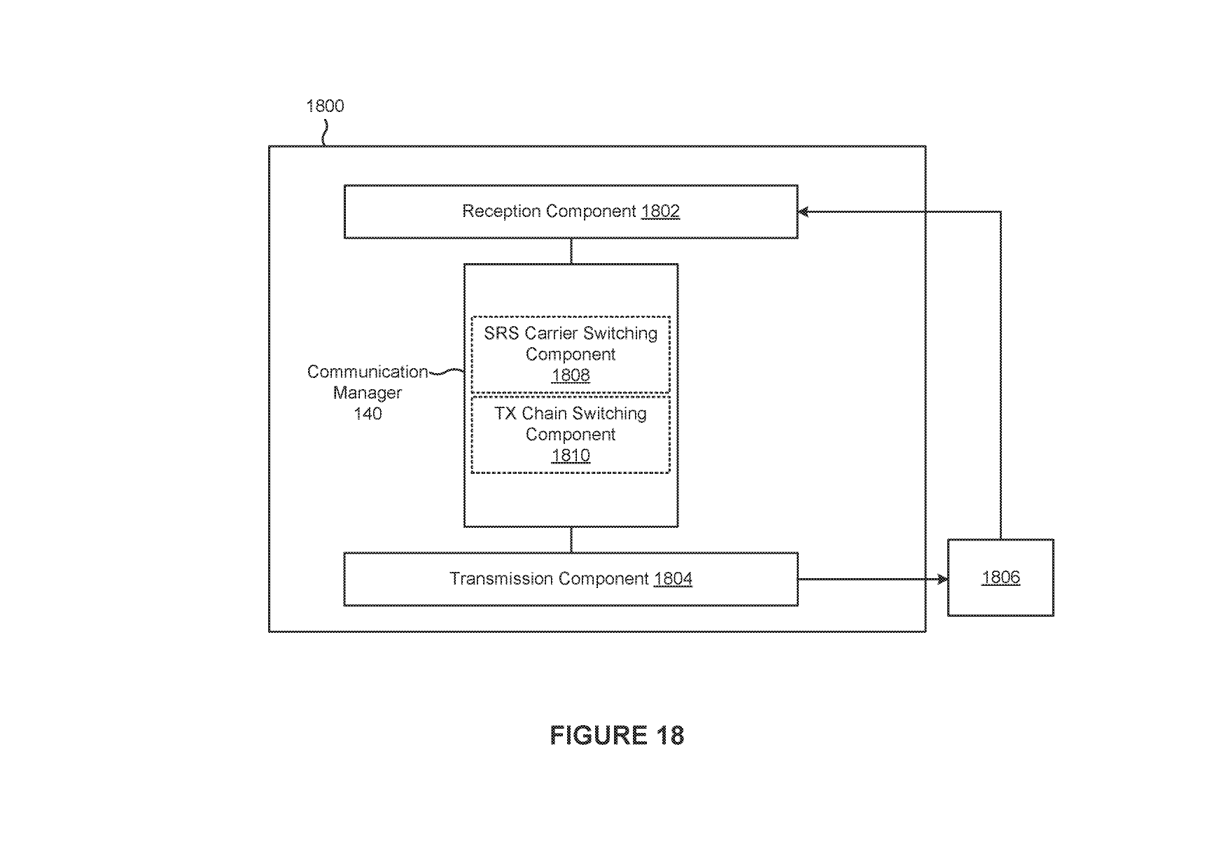

The network node 110, the controller/processor 240 of the network node 110, the UE 120, the controller/processor 280 of the UE 120, the CU 310, the DU 330, the RU 340, or any other component(s) of FIGS. 1,2 or 3, may implement one or more techniques or perform one or more operations associated with UL TX and SRS carrier switching, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1400 of FIG. 14, process 1500 of FIG. 15, process 1600 of FIG. 16, process 1700 of FIG. 17, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1500 of FIG. 15, process 1600 of FIG. 16, process 1700 of FIG. 17, process 1800 of FIG. 18, or other processes as described herein. In some examples, executing instructions may include running the instructions, converting the instructions, compiling the instructions, and/or interpreting the instructions, among other examples.

In some aspects, the UE 120 includes means for receiving an indication of an SRS carrier switching pattern; and/or means for performing SRS carrier switching between a plurality of carriers, wherein performing the SRS carrier switching includes sequentially transmitting an SRS to a plurality of cells associated with the plurality of carriers according to the SRS carrier switching pattern. Additionally or alternatively, the UE 120 includes means for receiving an indicator for coordinating UL TX switching and SRS carrier switching; means for switching at least one TX chain from a source carrier to a target carrier according to the indicator, wherein the source carrier is a source UL carrier or a source SRS carrier; and/or means for transmitting one or more uplink signals on the target carrier using the at least one TX chain, wherein the one or more uplink signals include one or more of an SRS or a PUSCH communication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, an indication of an SRS carrier switching pattern; and/or means for receiving, from the UE 120, an SRS at a plurality of cells associated with a plurality of carriers in a sequence associated with the SRS carrier switching pattern. Additionally or alternatively, the network node 110 includes means for transmitting, to a UE 120, an indicator for coordinating UL TX switching and SRS carrier switching, wherein the indicator enables the UE 120 to switch at least one TX chain from a source carrier to a target carrier, wherein the source carrier is a source UL carrier or a source SRS carrier; and/or means for receiving, from the UE 120, one or more uplink signals on the target carrier, wherein the one or more uplink signals include one or more of an SRS or a PUSCH communication. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

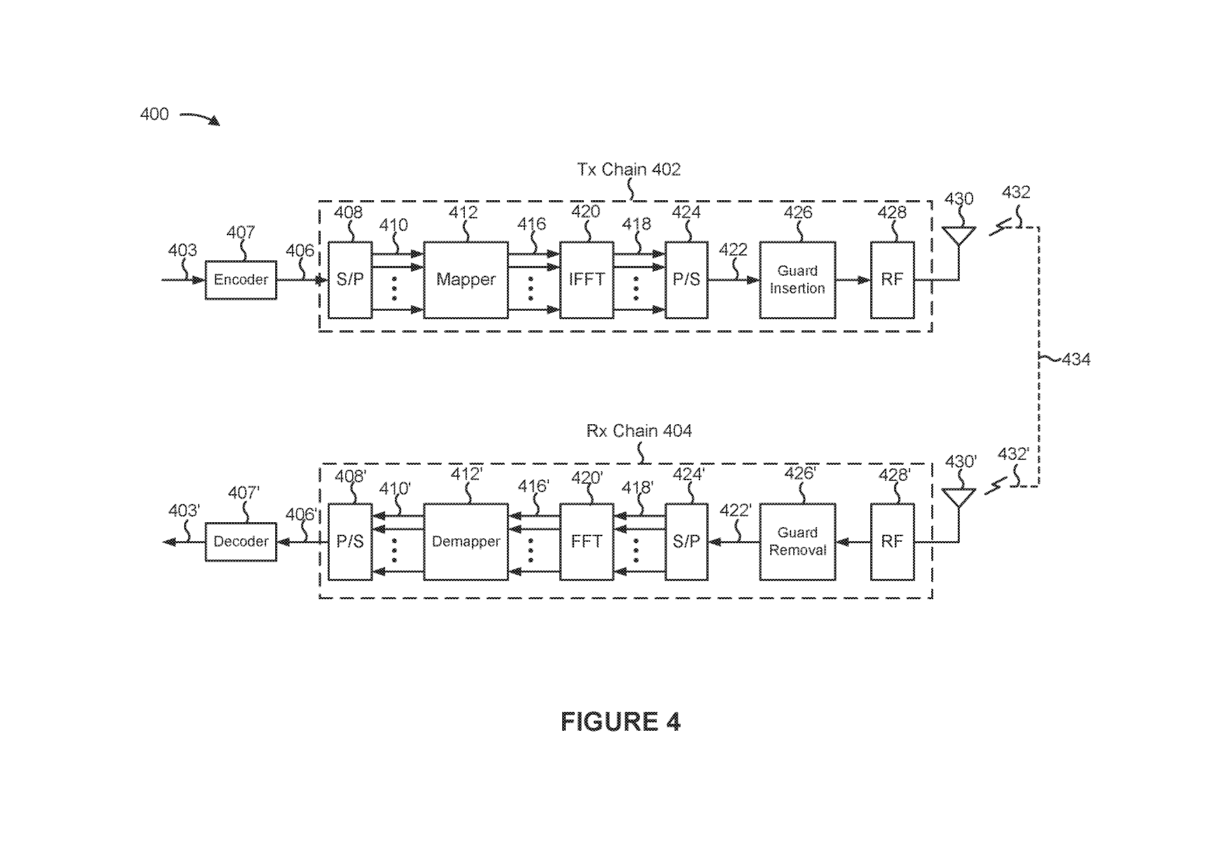

FIG. 4 is a diagram illustrating an example 400 of a TX chain 402 and a RX chain 404 of a UE 120 in accordance with the present disclosure. In some aspects, one or more components of TX chain 402 may be implemented in transmit processor 264, TX MIMO processor 266, modem 254, and/or controller/processor 280, as described above in connection with FIG. 2. In some aspects, TX chain 402 may be implemented in UE 120 for transmitting data 406 (for example, uplink data, an uplink reference signal (for example, an SRS), and/or uplink control information) to a network node 110 on an uplink channel.

An encoder 407 may alter a signal (for example, a bitstream) 403 into data 406. Data 406 to be transmitted is provided from encoder 407 as input to a serial-to-parallel (S/P) converter 408. In some aspects, S/P converter 408 may split the transmission data into N parallel data streams 410.

The N parallel data streams 410 may then be provided as input to a mapper 412. Mapper 412 may map the N parallel data streams 410 onto N constellation points. The mapping may be done using a modulation constellation, such as binary phase-shift keying (BPSK), quadrature phase-shift keying (QPSK), 8 phase-shift keying (8PSK), quadrature amplitude modulation (QAM), etc. Thus, mapper 412 may output N parallel symbol streams 416, each symbol stream 416 corresponding to one of N orthogonal subcarriers of an inverse fast Fourier transform (IFFT) component 420. These N parallel symbol streams 416 are represented in the frequency domain and may be converted into N parallel time domain sample streams 418 by IFFT component 420.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol) + N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of guard insertion component 426 may then be upconverted to a desired transmit frequency band by an RF front end 428. An antenna 430 may then transmit the resulting signal 432.

In some aspects, RX chain 404 may utilize OFDM/OFDMA. In some aspects, one or more components of RX chain 404 may be implemented in receive processor 258, MIMO detector 256, modem 254, and/or controller/processor 280, as described above in connection with FIG. 2. In some aspects, RX chain 404 may be implemented in UE 120 for receiving data 406 (for example, downlink data, a downlink reference signal, and/or downlink control information) from a network node 110 on a downlink channel.

A transmitted signal 432 is shown traveling over a wireless channel 434 from TX chain 402 to RX chain 404. When a signal 432' is received by an antenna 430', the received signal 432' may be downconverted to a baseband signal by an RF front end 428'. A guard removal component 426' may then remove the guard interval that was inserted between OFDM/OFDMA symbols by guard insertion component 426.

The output of guard removal component 426' may be provided to an S/P converter 424'. The output may include an OFDM/OFDMA symbol stream 422', and S/P converter 424' may divide the OFDM/OFDMA symbol stream 422' into N parallel time-domain symbol streams 418', each of which corresponds to one of the N orthogonal subcarriers. A fast Fourier transform (FFT) component 420' may convert the N parallel time-domain symbol streams 418' into the frequency domain and output N parallel frequency-domain symbol streams 416'.

A demapper 412' may perform the inverse of the symbol mapping operation that was performed by mapper 412, thereby outputting N parallel data streams 410'. A P/S converter 408' may combine the N parallel data streams 410' into a single data stream 406'. Ideally, data stream 406' corresponds to data 406 that was provided as input to TX chain 402. Data stream 406' may be decoded into a decoded data stream 403' by decoder 407'.

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally, or alternatively, a set of components (for example, one or more components) shown in FIG. 4 may perform one or more functions described as being performed by another set of components shown in FIG. 4.

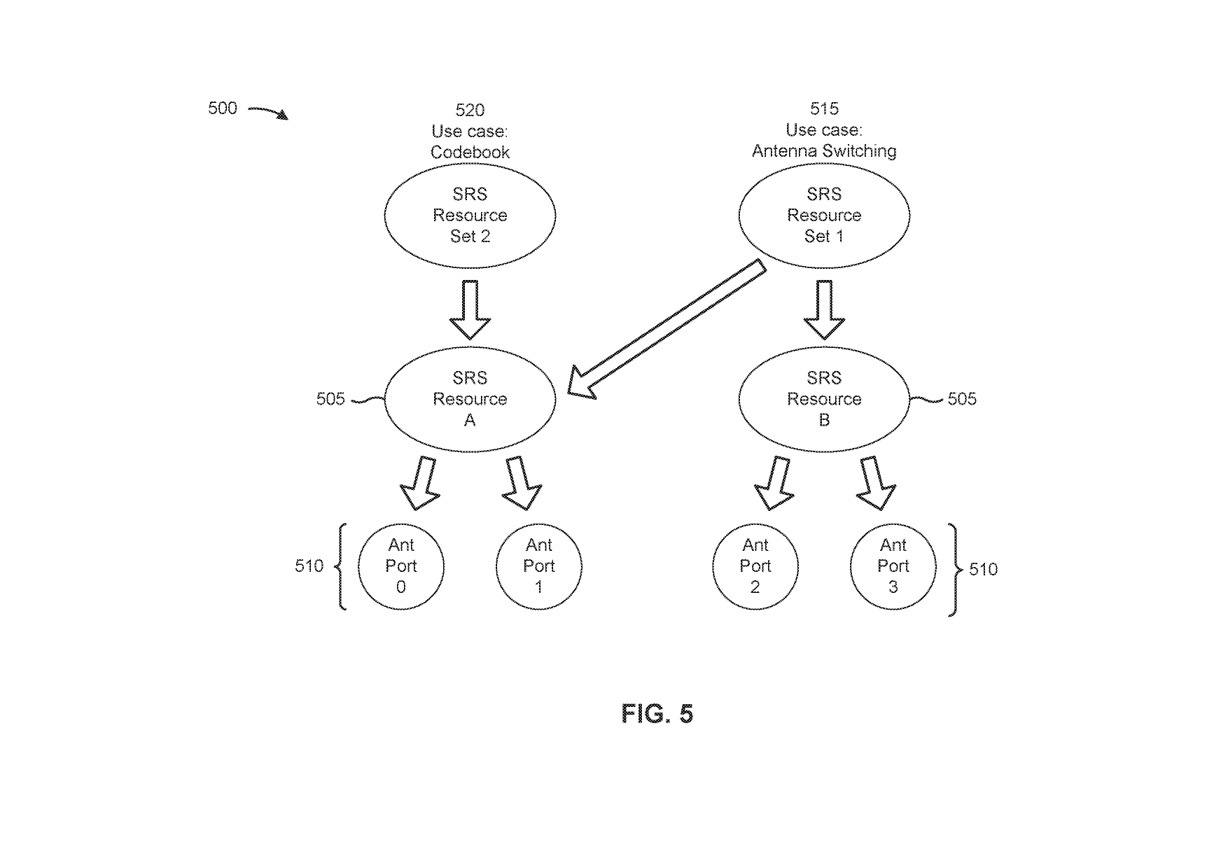

FIG. 5 is a diagram illustrating an example 500 of SRS resource sets in accordance with the present disclosure.

A UE 120 may be configured with one or more SRS resource sets to allocate resources for SRS transmissions by the UE 120. For example, a configuration for SRS resource sets may be indicated in an RRC message (for example, an RRC configuration message or an RRC reconfiguration message). As shown by reference number 505, an SRS resource set may include one or more resources (for example, shown as SRS resources), which may include time resources and/or frequency resources (for example, a slot, a symbol, a resource block, and/or a periodicity for the time resources). In some aspects, a configuration for SRS carrier switching patterns may be indicated in an RRC message and an indication of a selected SRS carrier switching pattern may be indicated in a MAC-CE or DCI message. In some aspects, a configuration for coordination between UL TX switching and SRS carrier switching may be indicated in an RRC message.

As shown by reference number 510, an SRS resource may include one or more antenna ports on which an SRS is to be transmitted (for example, in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (for example, in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a network node 110 may use an antenna switching SRS (for example, an SRS transmitted using a resource of an antenna switching SRS resource set) to acquire downlink CSI (for example, to determine a downlink precoder to be used to communicate with the UE 120). In this way, an SRS transmission can improve DL MIMO performance, even on DL-only cells.

A codebook SRS resource set may be used to indicate uplink CSI when a network node 110 indicates an uplink precoder to the UE 120. For example, when the network node 110 is configured to indicate an uplink precoder to the UE 120 (for example, using a precoder codebook), the network node 110 may use a codebook SRS (for example, an SRS transmitted using a resource of a codebook SRS resource set) to acquire uplink CSI (for example, to determine an uplink precoder to be indicated to the UE 120 and used by the UE 120 to communicate with the network node 110). In some aspects, virtual ports (for example, a combination of two or more antenna ports) with a maximum transmit power may be supported at least for a codebook SRS.

A non-codebook SRS resource set may be used to indicate uplink CSI when the UE 120 selects an uplink precoder (for example, instead of the network node 110 indicated an uplink precoder to be used by the UE 120). For example, when the UE 120 is configured to select an uplink precoder, the network node 110 may use a non-codebook SRS (for example, an SRS transmitted using a resource of a non-codebook SRS resource set) to acquire uplink CSI. In this case, the non-codebook SRS may be precoded using a precoder selected by the UE 120 (for example, which may be indicated to the network node 110).

A beam management SRS resource set may be used for indicating CSI for millimeter wave communications.

An SRS resource can be configured as periodic, semi-persistent, or aperiodic. A periodic SRS resource may be configured via a configuration message that indicates a periodicity of the SRS resource (for example, a slot-level periodicity, where the SRS resources occur every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (for example, using DCI or a MAC-CE). An aperiodic SRS resource may be triggered dynamically, such as via DCI (for example, UE-specific DCI or group common DCI) or a MAC-CE.

In some aspects, the UE 120 may be configured with a mapping between SRS ports (for example, antenna ports) and corresponding SRS resources. The UE 120 may transmit an SRS on a particular SRS resource using an SRS port indicated in the configuration. In some aspects, an SRS resource may span N adjacent symbols within a slot (for example, where N equals 1, 2, or 4). The UE 120 may be configured with X SRS ports (for example, where X ≤ 4). In some aspects, each of the X SRS ports may mapped to a corresponding symbol of the SRS resource and used for transmission of an SRS in that symbol.

As shown in FIG. 5, in some aspects, different SRS resource sets indicated to the UE 120 (for example, having different use cases) may overlap (for example, in time and/or in frequency, such as in the same slot). For example, as shown by reference number 515, a first SRS resource set (for example, shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (for example, a first time-frequency resource) using antenna port 0 and antenna port 1 and may be transmitted in SRS Resource B (for example, a second time-frequency resource) using antenna port 2 and antenna port 3.

As shown by reference number 520, a second SRS resource set (for example, shown as SRS Resource Set 2) may be a codebook use case. As shown, this example codebook SRS resource set includes only the first SRS resource (shown as SRS Resource A). Thus, codebook SRSs may be transmitted in SRS Resource A (for example, the first time-frequency resource) using antenna port 0 and antenna port 1. In this case, the UE 120 may not transmit codebook SRSs in SRS Resource B (for example, the second time-frequency resource) using antenna port 2 and antenna port 3.

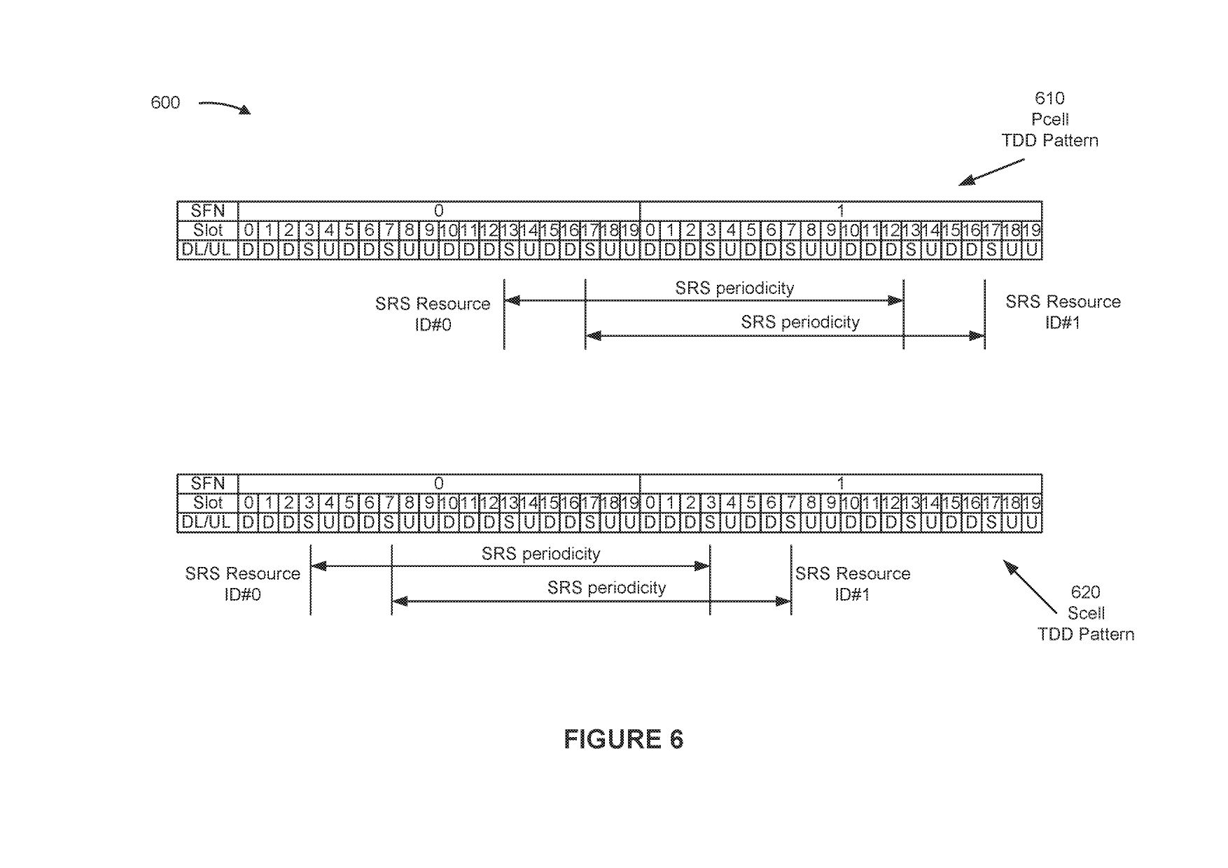

FIG. 6 is a diagram illustrating an example 600 of SRS carrier switching for DL carrier aggregation in accordance with the present disclosure.

As shown in FIG. 6, example 600 includes SRS carrier switching for DL carrier aggregation for a Pcell TDD pattern 610 and a DL-only Scell TDD pattern 620. The Pcell TDD pattern 610 and DL-only Scell TDD pattern 620 include a TDD pattern having DL slots (represented by “D”), UL slots (represented by “U”) and special slots (represented by “S”) for switching from DL to UL. SRS carrier switching enables SRS transmissions from a UE 120 to DL-only Scells in accordance with the capabilities of the UE 120 (for example, SRS carrier switching, SRS antenna switching with a supported band comb, or other capabilities). For example, SRS resources may be configured to be transmitted in certain UL slots (for example, SRS resource ID0 is associated with S slot 13, so that the SRS resource may be transmitted in UL slot 14, and so on). In the DL-only Scell TDD pattern 620, includes UL slots to enable SRS transmission despite there being no PUCCH/PUSCH resource configuration (for example, the UL slots are used only for SRS transmission). In this way, SRS carrier switching improves DL MIMO performance in DL-only Scells. For example, in DL carrier aggregation, a UE 120 may transmit an SRS to a Pcell that supports DL and UL communication and to a DL-only Scell. SRS carrier switching enables SRS-implemented DL MIMO for an Scell with a DL-only resource configuration for DL carrier aggregation.

For example, FIG. 6 illustrates a Pcell TDD pattern 610 that may include an SRS resource ID#0 having an SRS periodicity and an SRS Resource ID#1 having an SRS periodicity, where SRS resource ID#0 and SRS resource ID #1 are offset in the time domain (for example, by 4 slots in the illustrated example). An Scell TDD pattern 620 may include an SRS resource ID#0 having an SRS periodicity and an SRS resource ID#1 having an SRS periodicity, where SRS resource ID#0 and SRS resource ID#1 of the Scell TDD pattern 620 are offset from one another in the time domain (for example, by 4 slots in the illustrated example) and are additionally offset from the time domains of the SRS resource IDs of Pcell TDD pattern 610. In some aspects the SRS periodicity may be 10 ms or another suitable duration. In this way, SRS carrier switching facilitates SRS transmission to a DL/UL Scell and a DL-only Scell, which enables uplink channel estimation to improve DL performance at a DL-only Scell.

Although FIG. 6 illustrates the Pcell and the Scell including the same TDD pattern (for example, DDDSUDDSUU and DDDSUDDSUU, respectively), the TDD patterns in the Pcell and the Scell could be different. Similarly, although FIG. 6 illustrates the Pcell and the Scell as including the same SRS resource configurations (for example, SRS resource ID#0 and SRS resource ID#1), the configured SRS resources may differ between the Pcell and the Scell. Additionally, although FIG. 6 shows Pcell and the DL-only Scell TDD patterns that are aligned in time, but the Pcell and D-only Scell TDD patterns may be offset or otherwise unaligned in time.

As described herein, each SRS carrier switch is performed between a single Pcell and a DL-only Scell (for example, between the Pcell and a first Scell, the Pcell and a second Scell, the Pcell and a third Scell, and so on). As a result of this operation, every SRS carrier switch results in an interruption of DL and/or UL data transmissions. Such interruptions may lead to the use of potentially outdated channel estimation data because of the delay. Accordingly, changes to an SRS carrier switching pattern are needed to optimize the process efficiencies and improve downlink MIMO performance.

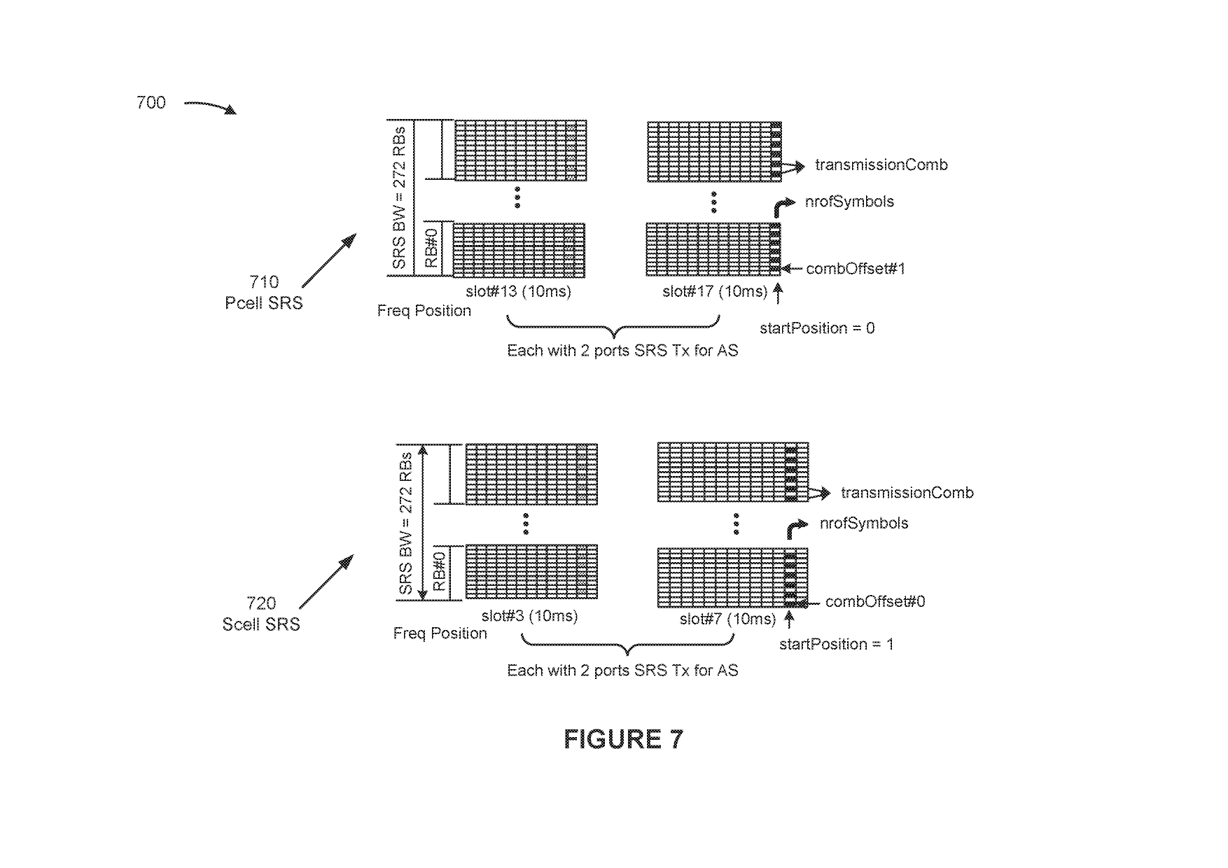

FIG. 7 is a diagram illustrating an example 700 of SRS carrier switching for DL carrier aggregation in accordance with the present disclosure.

As shown in FIG. 7, example 700 includes configurations for a Pcell SRS 710 with each configuration including two SRS TX ports for antenna switching (AS). Additionally, example 700 includes configurations for an Scell SRS 720 with each configuration including two SRS TX ports for AS. For example, each SRS configuration is associated with an SRS bandwidth (SRS BW) (for example, 272 resource blocks (RBs)) and a starting frequency position (for example, RB#0). Additionally, each SRS configuration is associated with a starting position (for example, startPosition=0) indicating a starting symbol of the SRS in the time domain, a transmission comb indicating a pattern of occupied subcarriers (for example, alternating on every other resource element (RE) for a transmissionComb = 2), a comb offset indicating a position of a first subcarrier (for example, combOffset#1), and a number of symbols used for SRS transmission (for example, nrofSymbols).

As described herein, SRS transmissions on a TDD Pcell and a TDD Scell may be on different switching slots. In this way, a UE 120 may transmit an SRS on the TDD Pcell in a slot, perform SRS carrier switching from the TDD Pcell to the TDD Scell, and then transmit an SRS on the TDD Scell in a later slot.

In some other cases, a network node 110 may request a UE 120 to report a carrier aggregation capability on a specific frequency band and to report an SRS carrier switching capability. A UE 120 may report a DL carrier aggregation capability (for example, a quantity of supported ports for DL carrier aggregation) and an SRS carrier switching capability (for example, a downlink switching time and an uplink switching time). For example, an uplink switching time may be 100 µs, which is an approximately 3 OFDM symbol time duration for a 30 kHz subcarrier spacing (SCS), or the uplink switching time may be a suitable duration.

As described herein, each SRS carrier switch between a Pcell and a DL-only Scell or between a DL-only Scell and a Pcell results in an interruption of DL and/or UL data transmissions due to the uplink switching time. Accordingly, some aspects described herein relate to sequential SRS carrier switching patterns that may reduce the switching time interruptions.

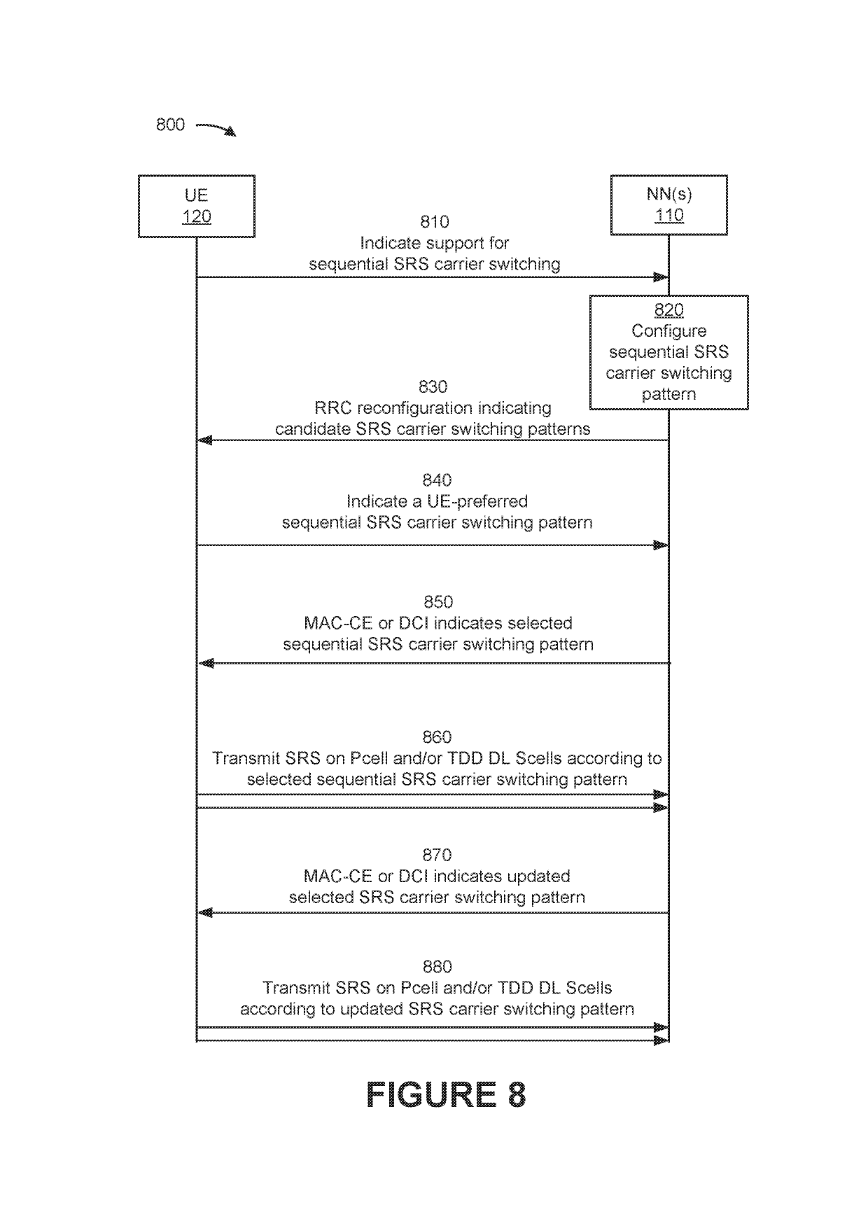

FIG. 8 is a diagram illustrating an example 800 associated with sequential SRS carrier switching in accordance with the present disclosure. As shown in FIG. 8, example 800 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In a first operation 810, the UE 120 may transmit, and the network node 110 may receive, an indication that the UE 120 supports sequential SRS carrier switching. For example, the UE 120 may indicate that the UE 120 supports sequential SRS carrier switching for a carrier aggregation configuration that includes multiple TDD DL-only Scells. In some aspects, the UE 120 may indicate the support for sequential SRS carrier switching for one or more band combinations.

In a second operation 820, the network node 110 may enable and configure a set of candidate sequential SRS carrier switching patterns. In some aspects, the SRS carrier switching patterns may enable SRS carrier switching among any quantity of cells. In such aspects, the cells included in a candidate SRS carrier switching pattern may include the Pcell and one or more DL-only Scells, or may include multiple DL-only Scells. Additionally, the Pcell and the DL-only Scell(s) may be in any suitable order within a given candidate sequential SRS carrier switching pattern.

In a third operation 830, the network node 110 may transmit, and the UE 120 may receive, an RRC reconfiguration that defines a set of sequential SRS carrier switching pattern candidates. For example, the set of sequential SRS carrier switching pattern candidates may include a plurality of pattern indexes, where each pattern index includes an SRS carrier switching pattern for sequential SRS carrier switching between a Pcell and a DL-only Scell or between multiple DL-only Scells. Additionally, the Pcell and the DL-only Scell(s) may be in any suitable order within a given SRS carrier switching pattern candidate. For example, each Pcell and each DL-only Scell may be associated with a respective identifier (for example, F0 for the Pcell, F1 for Scell 1, F2 for Scell 2, and so on). Each SRS carrier switching pattern index may be associated with a sequence of multiple identifiers, where each identifier corresponds to a cell. For example, in some example aspects, a pattern index may indicate a carrier switching pattern of F0→F1→F2→F3→F4, where the UE transmits a first SRS on the Pcell, then performs SRS carrier switching to Scell 1 to transmit an SRS on Scell 1, then performs SRS carrier switching to Scell 2 to transmit an SRS on Scell 2, then performs SRS carrier switching to Scell 3 to transmit an SRS on Scell 3, and then performs SRS carrier switching to Scell 4 to transmit an SRS on Scell 4. In some other examples, a carrier switching pattern of F0→F2→F4 indicates that the UE transmits a first SRS on the Pcell, then performs SRS carrier switching to Scell 2 to transmit an SRS on Scell 2, and then performs SRS carrier switching to Scell 4 to transmit an SRS on Scell 4. In some other example aspects, a pattern index may indicate a carrier switching pattern of F2→F4, where SRS carrier switching is performed on Scell 3 to transmit an SRS on Scell 3 and then SRS carrier switching is performed on Scell 5 to transmit an SRS on Scell 5. In some other example aspects, a pattern index may indicate a carrier switching pattern F1→F3, where SRS carrier switching is performed on Scell 1 to transmit an SRS on Scell 1 and then SRS carrier switching is performed on Scell 3 to transmit an SRS on Scell 5.

In a fourth operation 840, the UE 120 may transmit, and the network node 110 may receive, information indicating a preferred sequential SRS carrier switching pattern. For example, the UE 120 may determine the preferred sequential SRS carrier switching pattern according to performance parameters, including DL spectral efficiency measurements and/or predictions, UL and/or DL data interruption for SRS carrier switching, and/or other parameters. In some aspects, the UE 120 may transmit the indication of the UE-preferred sequential SRS carrier switching pattern via an RRC message, a MAC-CE, and/or a CSI report. In some aspects, the network node 110 may consider the UE-preferred sequential SRS carrier switching pattern in selecting a sequential SRS carrier switching pattern. In some other aspects, the network node 110 may select a sequential SRS carrier switching pattern independent of the UE-preferred sequential SRS carrier switching pattern.

In a fifth operation 850, the network node 110 may transmit, and the UE 120 may receive, a MAC-CE or DCI indicating a selected sequential SRS carrier switching pattern in accordance with network performance parameters. For example, in some aspects, the network node 110 may determine the selected sequential SRS carrier switching pattern in accordance with network performance parameters such as buffer size, network load, bandwidth, and/or predicted spectral efficiency on a TDD DL-only Scell, among other examples. In some aspects, the network node 110 may consider the UE-preferred sequential SRS carrier switching pattern in selecting a sequential SRS carrier switching pattern. In some other aspects, the network node 110 may select a sequential SRS carrier switching pattern independent of the UE-preferred sequential SRS carrier switching pattern. In some other aspects, the selected sequential SRS carrier switching pattern may be a pattern index selected from the configured set of sequential SRS carrier switching pattern candidates.

In a sixth operation 860, the UE 120 may perform sequential SRS carrier switching according to the SRS carrier switching pattern indicated by the network node 110. For example, the UE 120 may transmit an SRS to the Pcell and/or the TDD DL-only Scells according to the selected sequential SRS carrier switching pattern.

In a seventh operation 870, the network node 110 may transmit, and the UE 120 may receive, a MAC-CE or DCI indicating an updated selected SRS carrier switching pattern in accordance with network performance parameters. For example, in some aspects, the network node 110 may determine the updated selected sequential SRS carrier switching pattern in accordance with network performance parameters such as buffer size, network load, bandwidth, and/or predicted spectral efficiency on a TDD DL-only Scell, among other examples. In some other aspects, the network node 110 may consider the UE-preferred sequential SRS carrier switching pattern in selecting the updated sequential SRS carrier switching pattern. In some other aspects, the network node 110 may select the updated sequential SRS carrier switching pattern independent of the UE-preferred sequential SRS carrier switching pattern. In some other aspects, the updated sequential SRS carrier switching pattern may be a pattern index selected from the configured set of candidate sequential SRS carrier switching patterns.

In an eighth operation 880, the UE 120 may perform sequential SRS carrier switching according to the updated selected SRS carrier switching pattern indicated by the network node 110. For example, the UE 120 may transmit an SRS to the Pcell and/or the TDD DL-only Scells according to the updated selected SRS carrier switching patterns.

As described herein, SRS carrier switching results in an interruption of DL and/or UL data transmissions, depending on the capability of a UE on different band combinations. Accordingly, sequential SRS carrier switching according to a selected SRS carrier switching pattern may enable improved DL MIMO performance in Scells, reduce DL and/or UL data interruptions, and improve network performance. For example, by reducing the number of SRS carrier switches that utilize the Pcell as a pivot point for each SRS carrier switch, the number of data interruptions may be reduced. Additionally, the network node 110 may utilize updated performance parameters to adaptively and dynamically select an updated sequential SRS carrier switching pattern and thereby improve performance in response to changed network conditions and/or measurements.

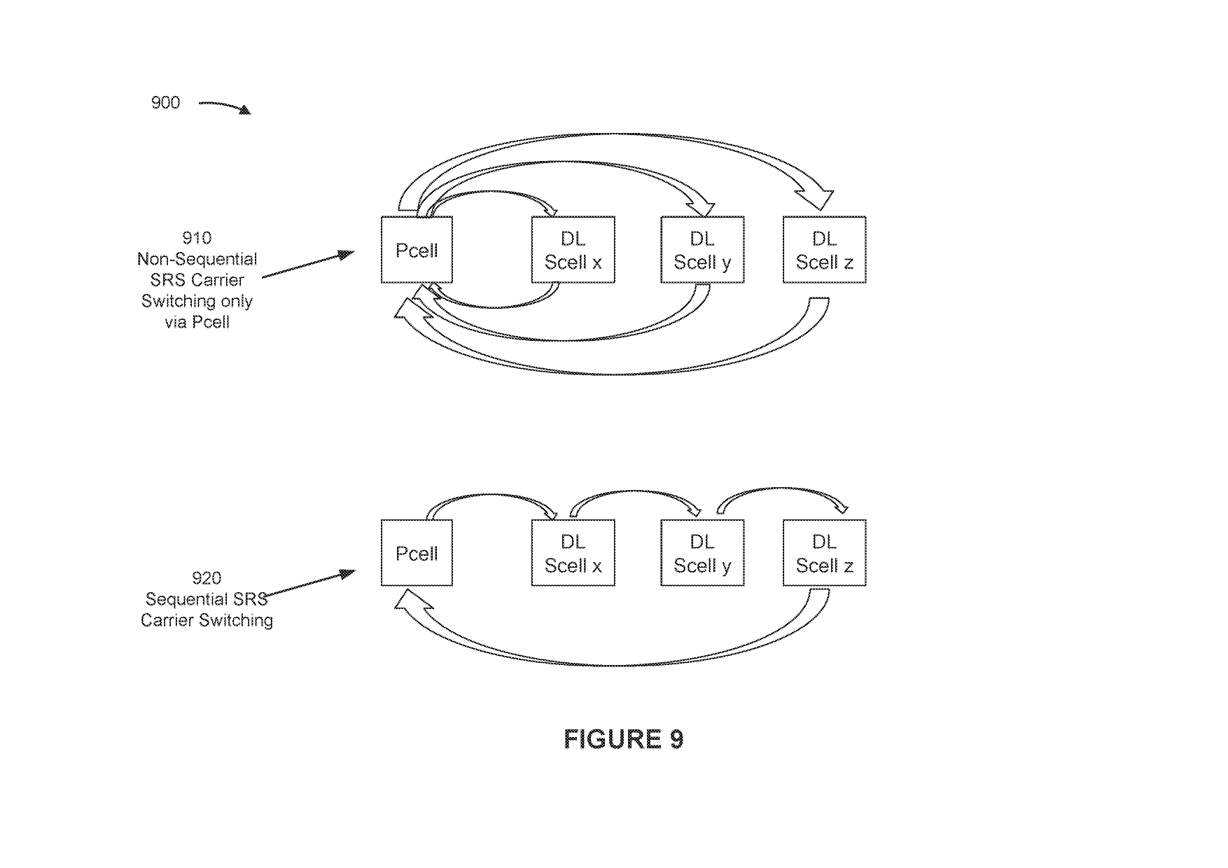

FIG. 9 is a diagram illustrating an example 900 associated with sequential SRS carrier switching in accordance with the present disclosure. As shown in FIG. 9, example 900 includes communication involving a Pcell and multiple DL-only Scells.

As shown in FIG. 9, reference number 910 includes an example of legacy non-sequential carrier switching, wherein SRS carrier switching is performed between a Pcell and each DL-only Scell. For example, as shown by reference number 910, SRS carrier switching may be performed between the Pcell and DL Scell x, followed by SRS carrier switching between the Pcell and DL Scell y, and followed by SRS carrier switching between the Pcell and DL Scell z, where the Pcell is a pivot point in each SRS carrier switch.

In contrast, reference number 920 includes an aspect of sequential SRS carrier switching, wherein SRS carrier switching is performed in any suitable sequence among a Pcell and one or more DL-only Scells, or only among DL-only Scells. For example, as shown by reference number 920, an initial SRS carrier switching may be performed from a Pcell to DL Scell x, followed by SRS carrier switching from DL Scell x to DL Scell y, and followed by SRS carrier switching from DL Scell y to DL Scell z. In such an example, the Pcell is the pivot point in the SRS carrier switch from the Pcell to Scell x, but the Pcell is not a pivot point in the SRS carrier switch from DL Scell x to DL Scell y or in the SRS carrier switching from DL Scell y to DL Scell z.

As described herein, each SRS carrier switch results in a DL and/or UL data transmission interruption that may lead to degraded network performance. Accordingly, sequential SRS carrier switching improves DL MIMO performance in Scells by reducing DL and/or UL data interruptions caused by SRS carrier switching, which in turn improves network performance by reducing network congestion, improving power conservation, and improving spectral efficiency.

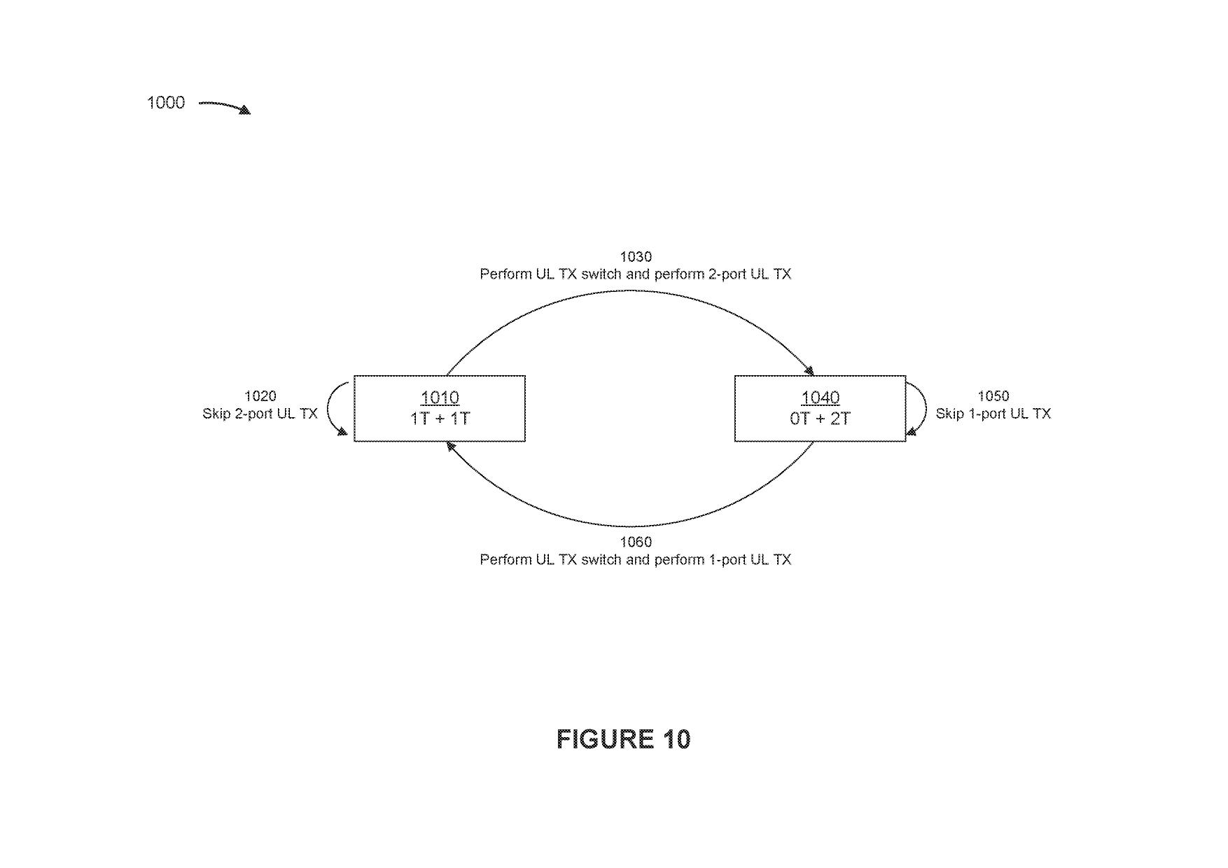

FIG. 10 is a diagram illustrating an example 1000 of UL TX switching in accordance with the present disclosure. As described herein, a UE 120 may be equipped with multiple TX chains, such as two TX chains. UL TX switching is a feature that enables a TX chain to be switched from one carrier to a different carrier and may enable a UE 120 to perform an UL TX that would otherwise be skipped.

For example, and as shown in FIG. 10, example 1010 illustrates an instance where two TX chains may be tuned to different carriers (for example, one TX chain may be on carrier A and one TX chain may be on carrier B). In example 1010, a UE 120 may be scheduled to perform a TDD PUSCH transmission, an aperiodic SRS (A-SRS) transmission, a configured grant UL transmission, or a periodic SRS (P-SRS) transmission with two ports on a carrier. Because the two TX chains are located on different carriers, the UE 120 may be unable to perform the two-port UL TX. Accordingly, the UE 120 may either skip the 2-port UL TX or perform UL TX switching to enable the 2-port UL TX. As shown by reference number 1020, the UE 120 may skip 2-port UL TX where each TX chain is on a different carrier (for example, when UL TX switching is not configured). Alternatively, as shown by reference number 1030, the UE 120 may perform an UL TX switch to switch a TX chain, resulting in two TX chains located on a single carrier (for example, two TX chains on carrier B) and thus enabling the UE to perform 2-port UL TX on the target carrier using two TX chains.

In an example 1040, two TX chains may be tuned to single carrier and no TX chains may be on the other carrier (for example, zero TX chains may be tuned to carrier A and two TX chains may be tuned to carrier B). In example 1040, a UE 120 may be scheduled to perform an FDD PUSCH transmission, an SRS transmission, a configured grant UL transmission, a PUCCH transmission, or a P-SRS transmission with one port on the carrier with zero TX chains. Because the two TX chains are on a single carrier (for example, carrier B), the UE 120 will be unable to perform the one-port UL TX on the other carrier (for example, carrier A). Accordingly, the UE 120 may either skip the 1-port UL TX or perform UL TX switching to enable the 1-port UL TX. As shown by reference number 1050, the UE 120 skips the 1-port UL TX where both TX chains are located on the single carrier. Alternatively, as shown by reference 1060, the UE 120 may perform an UL TX switch in order to switch a TX chain, resulting in one TX chain located on each carrier (for example, one TX chain on carrier A and one TX chain on carrier B) and thus enabling the UE to perform 1-port UL TX on the target carrier using one TX chain.

Additionally, for example, when UL TX switching is configured for a source cell (for example, an FDD Pcell), the UL TX configuration may indicate a target carrier for the UL TX switching, which may be different from a desired target carrier of the UL switch (for example, a TDD Scell). In such cases, the UE 120 may be unable to perform an UL TX switch from the source cell to the desired target cell. In some other examples, an UL TX switching option may be configured and/or enabled. For example, UL TX switching may be configured separately from SRS carrier switching for DL-only Scells, and the UL TX switching configuration and SRS carrier switching configuration may not be coordinated.

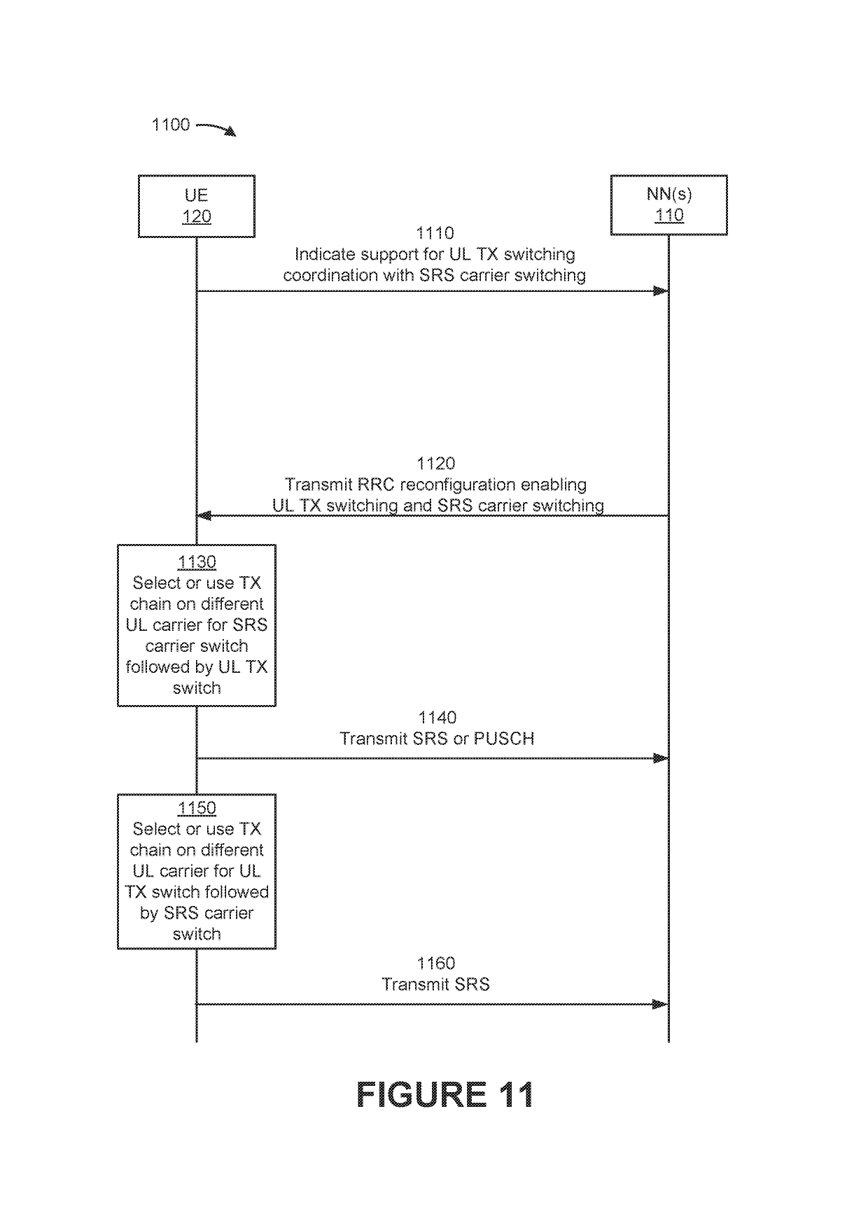

FIG. 11 is a diagram illustrating an example 1100 associated with coordination between UL TX switching and SRS carrier switching in accordance with the present disclosure. As shown in FIG. 11, example 1100 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In a first operation 1110, the UE 120 may transmit, and the network node 110 may receive, an indication that the UE 120 supports UL TX switching coordination with SRS carrier switching. In some aspects, the UE may support switching TX chains between different carriers associated with UL configurations (for example, UL TX switching) in a manner that is coordinated with switching TX chains to and/or from DL-only Scells (for example, SRS carrier switching).

In a second operation 1120, the network node 110 may enable and configure UL TX switching and SRS carrier switching coordination via an RRC configuration, where the network node 110 may transmit to the UE 120 an RRC configuration according to the UL TX switching and SRS carrier switching coordination configuration.

In a third operation 1130, the UE 120 may select or use a TX chain on a source carrier for SRS carrier switching (for example, a DL-only Scell), and the UE 120 may subsequently perform an UL TX switch from the source carrier to a target carrier associated with an uplink configuration according to the UL TX switching and SRS carrier switching coordination configuration. In a fourth operation 1140, the UE 120 may transmit to the network node 110 (for example, via the target carrier) an SRS or PUSCH TX according to the configuration enabling coordination between UL TX switching and SRS carrier switching.

In a fifth operation 1150, the UE 120 may select or use a TX chain on a source carrier for UL TX switching (for example an UL/DL Scell), and the UE 120 may subsequently perform SRS carrier switching from a source carrier to a target carrier according to the configuration enabling UL TX switching and SRS carrier switching coordination. In a sixth operation, 1160, the UE 120 may perform an SRS carrier switch, wherein the UE 120 may transmit an SRS.

As described herein, uncoordinated UL switching and SRS carrier switching may result in degraded network performance. For example, where a carrier configuration is not suitable for a scheduled UL TX (for example, one or more TX chains needed to perform the scheduled UL TX are tuned to a different carrier), the UE 120 may be forced to skip the UL TX when UL TX switching is not enabled. Additionally, by always using the Pcell as a pivot point, SRS transmissions may be delayed on a DL-only Scell, resulting in the DL-only Scell using a potentially outdated channel estimate. SRS transmission may also be impossible on a DL-only Scell when UL TX switching is enabled and there is no coordination between the SRS carrier switching and UL TX switching configurations. Additionally, using the Pcell as the sole pivot point may delay UL data transmissions and/or limit the number of layers utilized for UL data transmission on the DL/UL and/or UL-only Scell. Accordingly, by coordinating UL TX switching and SRS carrier switching, these carrier switching processes may be optimized for improved efficiency and performance.

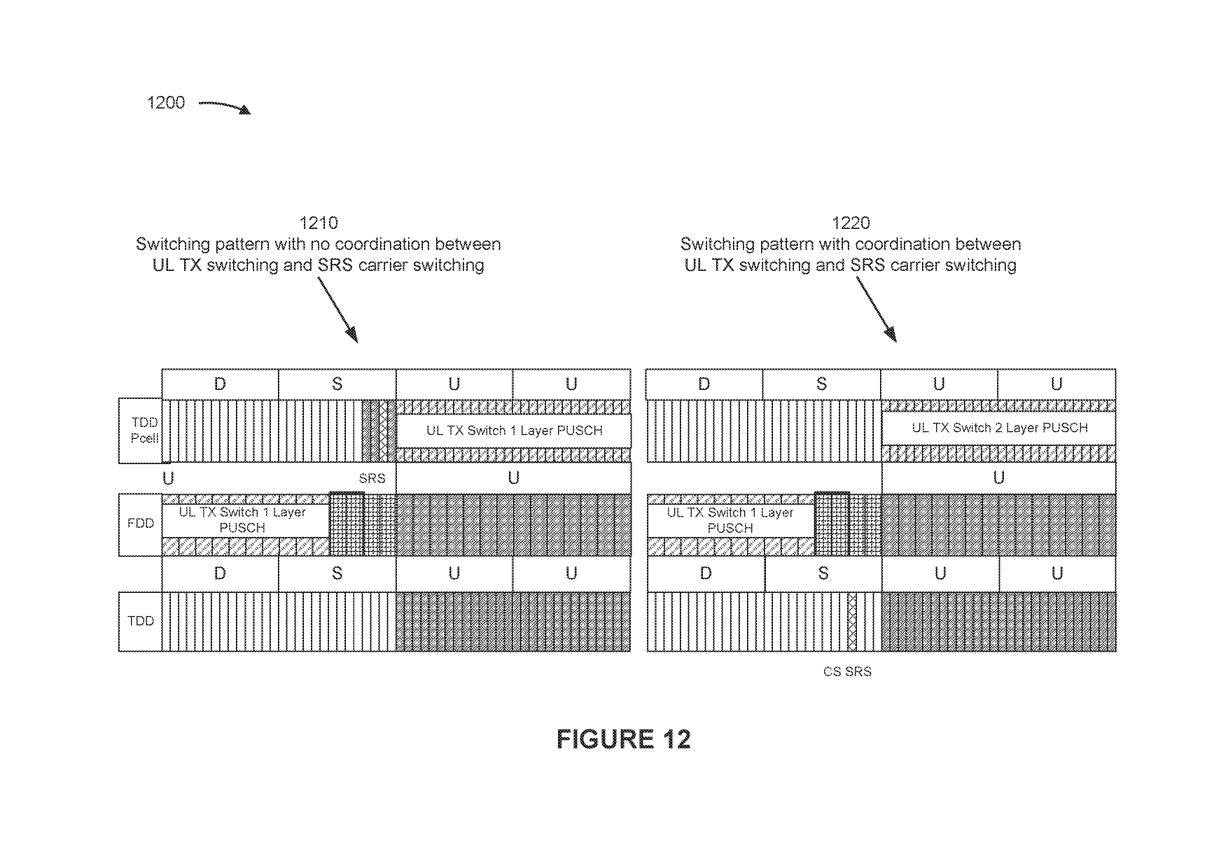

FIG. 12 is a diagram illustrating an example 1200 associated with coordination between UL TX switching and SRS carrier switching in accordance with the present disclosure. For example, FIG. 12 illustrates UL TX switching and SRS carrier switching performed in the context of a TDD Pcell, an UL/DL FDD Scell, and a DL-only TDD Scell.

As shown by reference number 1210, an example legacy switching pattern lacks coordination between UL TX switching and SRS carrier switching. For example, UL TX switching may be performed from the UL/DL FDD Scell to the TDD Pcell after performing a 1-layer PUSCH UL TX on the FDD Scell to enable an SRS transmission and a 1-layer PUSCH UL TX on the TDD Pcell. Transmission resources may be prepared on the TDD Pcell during the special slot (represented by “S”) after the 1-layer PUSCH TX on the FDD Scell and prior to the SRS transmission and the 1-layer PUSCH TX on the TDD Pcell. In such an example, SRS carrier switching is not performed at the DL-only TDD Scell (for example, the lack of coordination does not allow switching a TX chain to the DL-only TDD Scell, which reduces DL MIMO performance on the DL-only TDD Scell).

As shown by reference number 1220, some aspects may include coordination between UL TX switching and SRS carrier switching. This coordination is beneficial where the UL TX switching and SRS carrier switching are to occur, for example, among at least a Pcell, one or more DL/UL Scells, and one or more DL-only Scells. According to some aspects, UL TX switching may be performed from an UL/DL Scell to a TDD Pcell to switch from a 1-layer PUSCH UL TX on the FDD Scell to a 2-layer PUSCH UL TX on the TDD Pcell. SRS carrier switching may be performed from the FDD UL/DL Scell to the DL-only TDD Scell during the special slot (represented by “S”) between the 1-layer PUSCH TX on the FDD UL/DL Scell and the 2-layer PUSCH TX on the TDD Pcell. In such an example, the Pcell is not the pivot point for SRS carrier switching.

As described herein, when UL TX switching and SRS carrier switching are performed without coordination, a UE 120 may experience degraded performance and efficiency. For example, by coordinating UL TX switching and SRS carrier switching, DL MIMO performance may be improved in Scells by reducing DL and/or UL data interruptions caused by SRS carrier switching that utilizes the Pcell as the sole pivot point. In some aspects, network performance may be improved, including reduced network congestion, improved power conservation, and improved spectral efficiency. Accordingly, by implementing a configuration that enables coordination among UL TX switching and SRS carrier switching, both UL and DL performance may be improved.

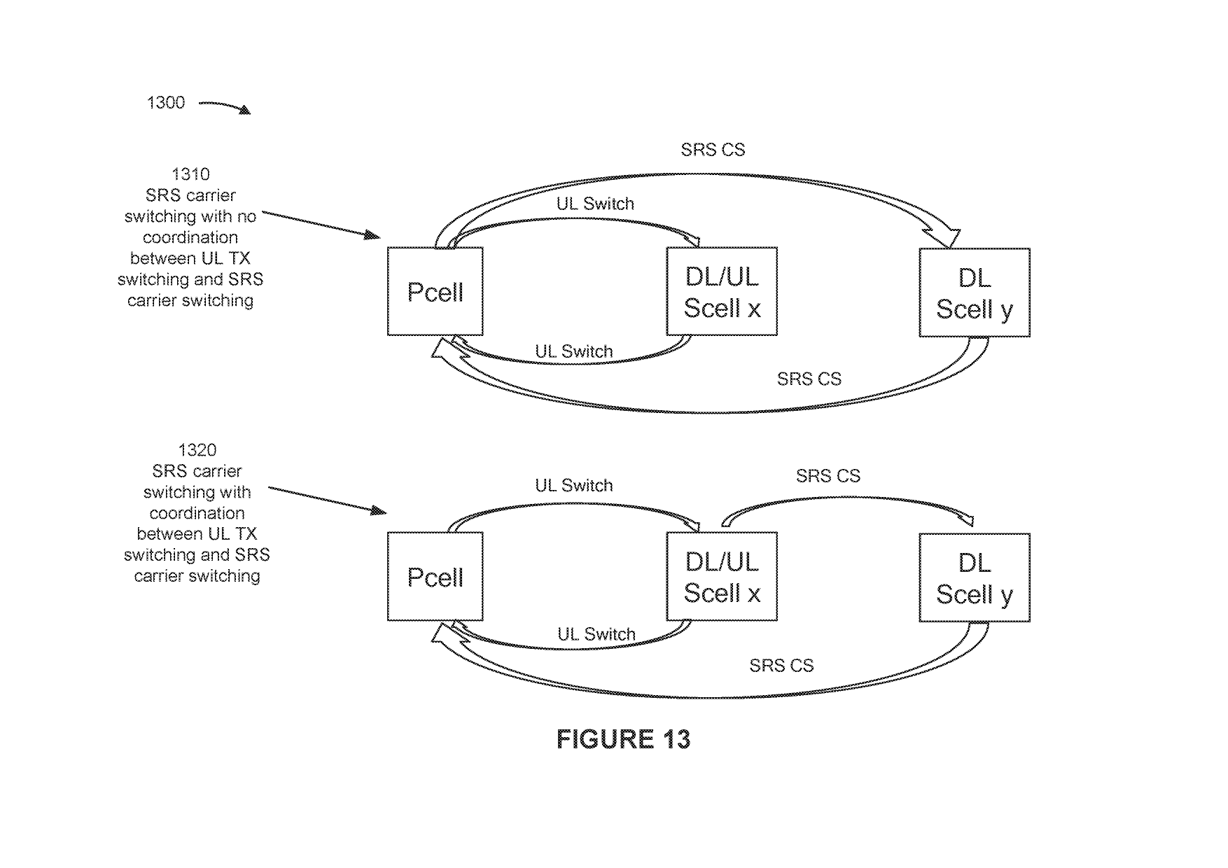

FIG. 13 is a diagram illustrating an example 1300 associated with coordination between UL TX switching and SRS carrier switching in accordance with the present disclosure. For example, FIG. 13 illustrates UL TX switching and SRS carrier switching performed in the context of a Pcell, one or more DL/UL Scells, and one or more DL-only Scells.

As shown by reference number 1310, an example legacy configuration lacks coordination between UL TX switching and SRS carrier switching. Additionally, both the UL TX switching and the SRS carrier switching are performed with the Pcell as the pivot point. For example, as shown by reference number 1310, UL TX switching may be performed between a Pcell and a DL/UL Scell. SRS carrier switching is subsequently performed between the Pcell and a DL-only Scell. For example, UL TX switching may be performed between a Pcell and a DL/UL Scell x, followed by SRS carrier switching between the Pcell and a DL-only Scell y. This uncoordinated process results in degraded performance for a UE 120.

In contrast, reference number 1320 includes coordinated UL TX switching and SRS carrier switching according to some aspects described herein, where UL TX switching is performed in any suitable sequence to switch one or more TX chains between a Pcell and one or more DL/UL Scells, and SRS carrier switching may be performed to switch one or more TX chains to or from one or more DL-only Scells. For example, UL TX switching may be performed from a Pcell to DL/UL Scell x, followed by SRS carrier switching from DL/UL Scell x to DL-only Scell y, and/or followed by UL TX switching from DL/UL Scell x to the Pcell. As described herein, the coordination between UL TX switching and SRS carrier switching configurations may improve both UL and DL performance.

FIG. 14 is a flowchart illustrating an example process 1400 performed, for example, at a UE or an apparatus of a UE that supports sequential SRS carrier switching in accordance with the present disclosure. Example process 1400 is an example where the apparatus or the UE (for example, UE 120) performs operations associated with SRS carrier switching.

As shown in FIG. 14, in some aspects, process 1400 may include receiving an indication of an SRS carrier switching pattern (block 1410). For example, the UE (such as by using communication manager 140 or reception component 1802, depicted in FIG. 18) may receive an indication of an SRS carrier switching pattern, as described above.

As further shown in FIG. 14, in some aspects, process 1400 may include performing SRS carrier switching between a plurality of carriers, wherein performing the SRS carrier switching includes sequentially transmitting an SRS to a plurality of cells associated with the plurality of carriers according to the SRS carrier switching pattern (block 1420). For example, the UE (such as by using communication manager 140 or SRS carrier switching component 1808, depicted in FIG. 18) may perform SRS carrier switching between a plurality of carriers, wherein performing the SRS carrier switching includes sequentially transmitting an SRS to a plurality of cells associated with the plurality of carriers according to the SRS carrier switching pattern, as described above.

Process 1400 may include additional aspects, such as any single aspect or any combination of aspects described below or in connection with one or more other processes described elsewhere herein.

In a first additional aspect, the SRS carrier switching pattern is associated with one or more performance parameters for the plurality of carriers.

In a second additional aspect, alone or in combination with the first aspect, process 1400 includes transmitting an indication of a preferred SRS carrier switching pattern, wherein the preferred SRS carrier switching pattern is associated with one or more performance parameters for the plurality of carriers.

In a third additional aspect, alone or in combination with one or more of the first and second aspects, process 1400 includes transmitting capability information that indicates a capability of the UE to support sequential SRS carrier switching.

In a fourth additional aspect, alone or in combination with one or more of the first through third aspects, process 1400 includes receiving an indication of an updated SRS carrier switching pattern, and performing SRS carrier switching between an updated plurality of carriers, wherein performing the SRS carrier switching includes sequentially transmitting an SRS to an updated plurality of cells associated with the updated plurality of carriers according to the updated SRS carrier switching pattern.

In a fifth additional aspect, alone or in combination with one or more of the first through fourth aspects, the SRS carrier switching is performed between a first carrier type and a second carrier type.

In a sixth additional aspect, alone or in combination with one or more of the first through fifth aspects, the SRS carrier switching is performed between carriers of the same type.

In a seventh additional aspect, alone or in combination with one or more of the first through sixth aspects, process 1400 includes receiving an RRC configuration that indicates a plurality of candidate SRS carrier switching patterns, wherein a PDCCH DCI or a MAC-CE indicates one of the plurality of candidate SRS carrier switching patterns according to the indication of the SRS carrier switching pattern.

In an eighth additional aspect, alone or in combination with one or more of the first through seventh aspects, the SRS carrier switching pattern does not require a primary cell as a pivot point for the SRS carrier switching.

Although FIG. 14 shows example blocks of process 1400, in some aspects, process 1400 may include additional blocks, fewer blocks, different blocks, or differently arranged blocks than those depicted in FIG. 14. Additionally or alternatively, two or more of the blocks of process 1400 may be performed in parallel.

FIG. 15 is a flowchart illustrating an example process 1500 performed, for example, at a UE or an apparatus of a UE that supports coordination between UL TX switching and SRS carrier switching in accordance with the present disclosure. Example process 1500 is an example where the apparatus or the UE (for example, UE 120) performs operations associated with UL TX switching and SRS carrier switching.

As shown in FIG. 15, in some aspects, process 1500 may include receiving an indicator for coordinating UL TX switching and SRS carrier switching (block 1510). For example, the UE (such as by using communication manager 140 or reception component 1802, depicted in FIG. 18) may receive an indicator for coordinating UL TX switching and SRS carrier switching, as described above.

As further shown in FIG. 15, in some aspects, process 1500 may include switching at least one TX chain from a source carrier to a target carrier according to the indicator, wherein the source carrier is a source UL carrier or a source SRS carrier (block 1520). For example, the UE (such as by using communication manager 140 and/or TX chain switching component 1810, depicted in FIG. 18) may switch at least one TX chain from a source carrier according to the indicator, wherein the source carrier is a source UL carrier or a source SRS carrier, as described above.

As further shown in FIG. 15, in some aspects, process 1500 may include transmitting one or more uplink signals on the target carrier using the at least one TX chain, wherein the one or more uplink signals include one or more of an SRS or a PUSCH communication (block 1530). For example, the UE (such as by using communication manager 140 or transmission component 1804, depicted in FIG. 18) may transmit one or more uplink signals on the target carrier using the at least one TX chain, wherein the one or more uplink signals include one or more of an SRS or a PUSCH communication, as described above.

Process 1500 may include additional aspects, such as any single aspect or any combination of aspects described below or in connection with one or more other processes described elsewhere herein.

In a first additional aspect, process 1500 includes transmitting capability information that indicates a capability of the UE to support UL TX switching and SRS carrier switching coordination.

In a second additional aspect, alone or in combination with the first aspect, switching the at least one TX chain from the source carrier and transmitting the one or more uplink signals are performed sequentially according to the indicator.

In a third additional aspect, alone or in combination with one or more of the first and second aspects, switching the at least one TX chain from the source carrier includes performing UL TX carrier switching in accordance with the source carrier and the target carrier both supporting UL data transmission or SRS carrier switching.

In a fourth additional aspect, alone or in combination with one or more of the first through third aspects, switching the at least one TX chain includes performing SRS carrier switching in accordance with one or more of the source carrier or the target carrier having a downlink-only configuration.

Although FIG. 15 shows example blocks of process 1500, in some aspects, process 1500 may include additional blocks, fewer blocks, different blocks, or differently arranged blocks than those depicted in FIG. 15. Additionally or alternatively, two or more of the blocks of process 1500 may be performed in parallel.

FIG. 16 is a flowchart illustrating an example process 1600 performed, for example, at a network node or an apparatus of a network node that supports sequential SRS carrier switching in accordance with the present disclosure. Example process 1600 is an example where the apparatus or the network node (for example, network node 110) performs operations associated with SRS carrier switching.

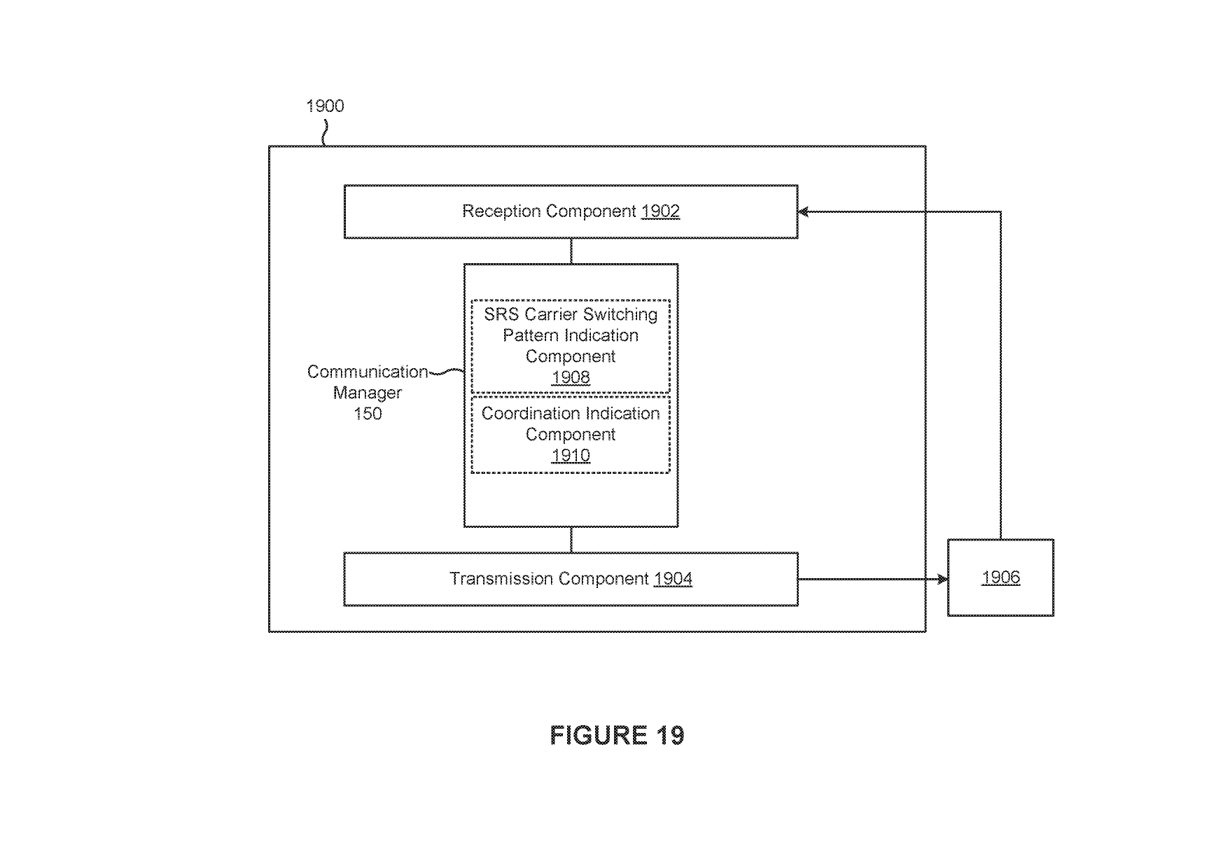

As shown in FIG. 16, in some aspects, process 1600 may include transmitting, to a UE, an indication of an SRS carrier switching pattern (block 1610). For example, the network node (such as by using communication manager 150 or transmission component 1904, depicted in FIG. 19) may transmit, to a UE, an indication of an SRS carrier switching pattern, as described above.

As further shown in FIG. 16, in some aspects, process 1600 may include receiving, from the UE, an SRS at a plurality of cells associated with a plurality of carriers in a sequence associated with the SRS carrier switching pattern (block 1620). For example, the network node (such as by using communication manager 150 or reception component 1902, depicted in FIG. 19) may receive, from the UE, an SRS at a plurality of cells associated with a plurality of carriers in a sequence associated with the SRS carrier switching pattern, as described above.

Process 1600 may include additional aspects, such as any single aspect or any combination of aspects described below or in connection with one or more other processes described elsewhere herein.

In a first additional aspect, the SRS carrier switching pattern is associated with one or more performance parameters for the plurality of carriers.

In a second additional aspect, alone or in combination with the first aspect, process 1600 includes receiving, from the UE, an indication of a preferred SRS carrier switching pattern, wherein the preferred SRS carrier switching pattern is associated with one or more performance parameters for the plurality of carriers.

In a third additional aspect, alone or in combination with one or more of the first and second aspects, process 1600 includes receiving, from the UE, capability information that indicates a capability of the UE to support sequential SRS carrier switching.

In a fourth additional aspect, alone or in combination with one or more of the first through third aspects, process 1600 includes transmitting, to the UE, an indication of an updated SRS carrier switching pattern, and receiving, from the UE, an SRS at an updated plurality of cells associated with an updated plurality of carriers in an updated sequence associated with the updated SRS carrier switching pattern.

In a fifth additional aspect, alone or in combination with one or more of the first through fourth aspects, the plurality of carriers include a first carrier type and a second carrier type.

In a sixth additional aspect, alone or in combination with one or more of the first through fifth aspects, the plurality of carriers are of the same carrier type.

In a seventh additional aspect, alone or in combination with one or more of the first through sixth aspects, process 1600 includes transmitting, to the UE, an RRC configuration that indicates a plurality of candidate SRS carrier switching patterns, wherein a PDCCH DCI or a MAC-CE indicates one of the plurality of candidate SRS carrier switching patterns according to the indication of the SRS carrier switching pattern.

Although FIG. 16 shows example blocks of process 1600, in some aspects, process 1600 may include additional blocks, fewer blocks, different blocks, or differently arranged blocks than those depicted in FIG. 16. Additionally or alternatively, two or more of the blocks of process 1600 may be performed in parallel.

FIG. 17 is a flowchart illustrating an example process 1700 performed, for example, at a network node or an apparatus of a network node that supports coordination between UL TX switching and SRS carrier switching in accordance with the present disclosure. Example process 1700 is an example where the apparatus or the network node (for example, network node 110) performs operations associated with UL TX switching and SRS carrier switching.

As shown in FIG. 17, in some aspects, process 1700 may include transmitting, to a UE, an indicator for coordinating UL TX switching and SRS carrier switching, wherein the indicator enables the UE to switch at least one TX chain from a source carrier to a target carrier, wherein the source carrier is a source UL carrier or a source SRS carrier (block 1710). For example, the network node (such as by using communication manager 150 or transmission component 1904, depicted in FIG. 19) may transmit, to a UE, an indicator for coordinating UL TX switching and SRS carrier switching, wherein the indicator enables the UE to switch at least one TX chain from a source carrier to a target carrier, wherein the source carrier is a source UL carrier or a source SRS carrier, as described above.

As further shown in FIG. 17, in some aspects, process 1700 may include receiving, from the UE, one or more uplink signals on the target carrier, wherein the one or more uplink signals include one or more of an SRS or a PUSCH communication (block 1720). For example, the network node (such as by using communication manager 150 or reception component 1902, depicted in FIG. 19) may receive, from the UE, one or more uplink signals on the target carrier, wherein the one or more uplink signals include one or more of an SRS or a PUSCH communication, as described above.

Process 1700 may include additional aspects, such as any single aspect or any combination of aspects described below or in connection with one or more other processes described elsewhere herein.

In a first additional aspect, process 1700 includes receiving, from the UE, capability information that indicates a capability of the UE to support UL TX switching and SRS carrier switching coordination.

In a second additional aspect, alone or in combination with the first aspect, the indicator enables the UE to perform UL switching for the at least one TX chain in accordance with the source carrier and the target carrier both supporting UL data transmission.

In a third additional aspect, alone or in combination with one or more of the first and second aspects, the indicator enables the UE to perform SRS carrier switching for the at least one TX chain in accordance with one or more of the source carrier or the target carrier having a downlink-only configuration.

Although FIG. 17 shows example blocks of process 1700, in some aspects, process 1700 may include additional blocks, fewer blocks, different blocks, or differently arranged blocks than those depicted in FIG. 17. Additionally or alternatively, two or more of the blocks of process 1700 may be performed in parallel.

FIG. 18 is a diagram of an example apparatus 1800 for wireless communication that supports sequential SRS carrier switching and/or coordination between UL TX switching and SRS carrier switching in accordance with the present disclosure. The apparatus 1800 may be a UE, or a UE may include the apparatus 1800. In some aspects, the apparatus 1800 includes a reception component 1802, a transmission component 1804, and a communication manager 140, which may be in communication with one another (for example, via one or more buses). As shown, the apparatus 1800 may communicate with another apparatus 1806 (such as a UE, a network node, or another wireless communication device) using the reception component 1802 and the transmission component 1804.

In some aspects, the apparatus 1800 may be configured to and/or operable to perform one or more operations described herein in connection with FIGS. 8-9 and 11-13. Additionally or alternatively, the apparatus 1800 may be configured to and/or operable to perform one or more processes described herein, such as process 1400 of FIG. 14, process 1500 of FIG. 15, and/or a combination thereof. In some aspects, the apparatus 1800 may include one or more components of the UE described above in connection with FIG. 1 and FIG. 2.

The reception component 1802 may receive communications, such as reference signals, control information, and/or data communications, from the apparatus 1806. The reception component 1802 may provide received communications to one or more other components of the apparatus 1800, such as the communication manager 140. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1802 may include one or more antennas, one or more modems, one or more demodulators, one or more MIMO detectors, one or more receive processors, one or more controllers/processors, and/or one or more memories of the UE described above in connection with FIG. 1 and FIG. 2.

The transmission component 1804 may transmit communications, such as reference signals, control information, and/or data communications, to the apparatus 1806. In some aspects, the communication manager 140 may generate communications and may transmit the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, one or more modems, one or more modulators, one or more transmit MIMO processors, one or more transmit processors, one or more controllers/processors, and/or one or more memories of the UE described above in connection with FIG. 1 and FIG. 2. In some aspects, the transmission component 1804 may be co-located with the reception component 1802 in one or more transceivers.

The communication manager 140 may receive or may cause the reception component 1802 to receive an indication of an SRS carrier switching pattern. The communication manager 140 may perform SRS carrier switching between a plurality of carriers, wherein performing the SRS carrier switching includes sequentially transmitting an SRS to a plurality of cells associated with the plurality of carriers according to the SRS carrier switching pattern. In some aspects, the communication manager 140 may perform one or more operations described elsewhere herein as being performed by one or more components of the communication manager 140.

The communication manager 140 may receive or may cause the reception component 1802 to receive an indicator for coordinating UL TX switching and SRS carrier switching. The communication manager 140 may switch at least one TX chain from a source carrier according to the indicator, wherein the source carrier is a source UL carrier or a source SRS carrier. The communication manager 140 may transmit or may cause the transmission component 1804 to transmit one or more uplink signals on the target carrier using the at least one TX chain, wherein the one or more uplink signals include one or more of an SRS or a PUSCH communication. In some aspects, the communication manager 140 may perform one or more operations described elsewhere herein as being performed by one or more components of the communication manager 140.

The communication manager 140 may include one or more controllers/processors and/or one or more memories of the UE described above in connection with FIG. 1 and FIG. 2. In some aspects, the communication manager 140 includes a set of components, such as an SRS carrier switching component 1808 and/or a TX chain switching component 1810. Alternatively, the set of components may be separate and distinct from the communication manager 140. In some aspects, one or more components of the set of components may include or may be implemented within one or more controllers/processors and one or more memories of the UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive an indication of an SRS carrier switching pattern. The SRS carrier switching component 1808 may perform SRS carrier switching between a plurality of carriers, wherein performing the SRS carrier switching includes sequentially transmitting an SRS to a plurality of cells associated with the plurality of carriers according to the SRS carrier switching pattern.

The transmission component 1804 may transmit an indication of a preferred SRS carrier switching pattern, wherein the preferred SRS carrier switching pattern is associated with one or more performance parameters for the plurality of carriers.

The transmission component 1804 may transmit capability information that indicates a capability of the UE to support sequential SRS carrier switching.

The reception component 1802 may receive an indication of an updated SRS carrier switching pattern.

The SRS carrier switching component 1808 may perform SRS carrier switching between an updated plurality of carriers, wherein performing the SRS carrier switching includes sequentially transmitting an SRS to an updated plurality of cells associated with the updated plurality of carriers according to the updated SRS carrier switching pattern.

The reception component 1802 may receive an RRC configuration that indicates a plurality of candidate SRS carrier switching patterns, wherein a PDCCH DCI or a MAC-CE indicates one of the plurality of candidate SRS carrier switching patterns according to the indication of the SRS carrier switching pattern.

The reception component 1802 may receive an indicator for coordinating UL TX switching and SRS carrier switching. The TX chain switching component 1810 may switch at least one TX chain from a source carrier to a target carrier according to the indicator, wherein the source carrier is a source UL carrier or a source SRS carrier. The transmission component 1804 may transmit one or more uplink signals on the target carrier using the at least one TX chain, wherein the one or more uplink signals include one or more of an SRS or a PUSCH communication.

The transmission component 1804 may transmit capability information that indicates a capability of the UE to support UL TX switching and SRS carrier switching coordination.

The quantity and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally or alternatively, a set of (one or more) components shown in FIG. 18 may perform one or more functions described as being performed by another set of components shown in FIG. 18.

FIG. 19 is a diagram of an example apparatus 1900 for wireless communication that supports sequential SRS carrier switching and coordination of UL TX switching and SRS carrier switching in accordance with the present disclosure. The apparatus 1900 may be a network node, or a network node may include the apparatus 1900. In some aspects, the apparatus 1900 includes a reception component 1902, a transmission component 1904, and a communication manager 150, which may be in communication with one another (for example, via one or more buses). As shown, the apparatus 1900 may communicate with another apparatus 1906 (such as a UE, a network node, or another wireless communication device) using the reception component 1902 and the transmission component 1904.

In some aspects, the apparatus 1900 may be configured to and/or operable to perform one or more operations described herein in connection with FIGS. 8-9 and 11-13. Additionally or alternatively, the apparatus 1900 may be configured to and/or operable to perform one or more processes described herein, such as process 1600 of FIG. 16, and/or process 1700 of FIG. 17. In some aspects, the apparatus 1900 may include one or more components of the network node described above in connection with FIG. 1 and FIG. 2.

The reception component 1902 may receive communications, such as reference signals, control information, and/or data communications, from the apparatus 1906. The reception component 1902 may provide received communications to one or more other components of the apparatus 1900, such as the communication manager 150. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1902 may include one or more antennas, one or more modems, one or more demodulators, one or more MIMO detectors, one or more receive processors, one or more controllers/processors, and/or one or more memories of the network node described above in connection with FIG. 1 and FIG. 2.

The transmission component 1904 may transmit communications, such as reference signals, control information, and/or data communications, to the apparatus 1906. In some aspects, the communication manager 150 may generate communications and may transmit the generated communications to the transmission component 1904 for transmission to the apparatus 1906. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1906. In some aspects, the transmission component 1904 may include one or more antennas, one or more modems, one or more modulators, one or more transmit MIMO processors, one or more transmit processors, one or more controllers/processors, and/or one or more memories of the network node described above in connection with FIG. 1 and FIG. 2. In some aspects, the transmission component 1904 may be co-located with the reception component 1902 in one or more transceivers.

The communication manager 150 may transmit or may cause the transmission component 1904 to transmit, to a UE, an indication of an SRS carrier switching pattern. The communication manager 150 may receive or may cause the reception component 1902 to receive, from the UE, an SRS at a plurality of cells associated with a plurality of carriers in a sequence associated with the SRS carrier switching pattern. In some aspects, the communication manager 150 may perform one or more operations described elsewhere herein as being performed by one or more components of the communication manager 150.

The communication manager 150 may transmit or may cause the transmission component 1904 to transmit, to a UE, an indicator for coordinating UL TX switching and SRS carrier switching, wherein the indicator enables the UE to switch at least one TX chain from a source carrier to a target carrier, wherein the source carrier is a source UL carrier or a source SRS carrier. The communication manager 150 may receive or may cause the reception component 1902 to receive, from the UE, one or more uplink signals on the target carrier, wherein the one or more uplink signals include one or more of an SRS or a PUSCH communication. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 1 and FIG. 2. In some aspects, the communication manager 150 includes a set of components, such as a SRS carrier switching pattern indication component 1908, and/or a coordination indication component 1910. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1904 may transmit, to a UE, an indication of an SRS carrier switching pattern. The reception component 1902 may receive, from the UE, an SRS at a plurality of cells associated with a plurality of carriers in a sequence associated with the SRS carrier switching pattern.

The reception component 1902 may receive, from the UE, an indication of a preferred SRS carrier switching pattern, wherein the preferred SRS carrier switching pattern is associated with one or more performance parameters for the plurality of carriers.

The reception component 1902 may receive, from the UE, capability information that indicates a capability of the UE to support sequential SRS carrier switching.

The transmission component 1904 may transmit, to the UE, an indication of an updated SRS carrier switching pattern.

The reception component 1902 may receive, from the UE, an SRS at an updated plurality of cells associated with an updated plurality of carriers in an updated sequence associated with the updated SRS carrier switching pattern.

The transmission component 1904 may transmit, to the UE, an RRC configuration that indicates a plurality of candidate SRS carrier switching patterns, wherein a PDCCH downlink control information DCI or a MAC-CE indicates one of the plurality of candidate SRS carrier switching patterns according to the indication of the SRS carrier switching pattern.

The transmission component 1904 may transmit, to a UE, an indicator for coordinating UL TX switching and SRS carrier switching, wherein the indicator enables the UE to switch at least one TX chain from a source carrier to a target carrier, wherein the source carrier is a source UL carrier or a source SRS carrier. The reception component 1902 may receive, from the UE, one or more uplink signals on the target carrier, wherein the one or more uplink signals include one or more of an SRS or a PUSCH communication.

The reception component 1902 may receive, from the UE, capability information that indicates a capability of the UE to support UL TX switching and SRS carrier switching coordination.

The quantity and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally or alternatively, a set of (one or more) components shown in FIG. 19 may perform one or more functions described as being performed by another set of components shown in FIG. 19.

The following provides an overview of some Aspects of the present disclosure:

Aspect 1: A method for wireless communication by a user equipment (UE), comprising: receiving an indication of a sounding reference signal (SRS) carrier switching pattern; and performing SRS carrier switching between a plurality of carriers, wherein performing the SRS carrier switching includes sequentially transmitting an SRS to a plurality of cells associated with the plurality of carriers according to the SRS carrier switching pattern.

Aspect 2: The method of Aspect 1, wherein the SRS carrier switching pattern is associated with one or more performance parameters for the plurality of carriers.

Aspect 3: The method of any of Aspects 1-2, further comprising: transmitting an indication of a preferred SRS carrier switching pattern, wherein the preferred SRS carrier switching pattern is associated with one or more performance parameters for the plurality of carriers.

Aspect 4: The method of any of Aspects 1-3, further comprising: transmitting capability information that indicates a capability of the UE to support sequential SRS carrier switching.

Aspect 5: The method of any of Aspects 1-4, further comprising: receiving an indication of an updated SRS carrier switching pattern; and performing SRS carrier switching between an updated plurality of carriers, wherein performing the SRS carrier switching includes sequentially transmitting an SRS to an updated plurality of cells associated with the updated plurality of carriers according to the updated SRS carrier switching pattern.

Aspect 6: The method of any of Aspects 1-5, wherein the SRS carrier switching is performed between a first carrier type and a second carrier type.

Aspect 7: The method of any of Aspects 1-6, wherein the SRS carrier switching is performed between carriers of the same type.

Aspect 8: The method of any of Aspects 1-7, further comprising: receiving a radio resource control (RRC) configuration that indicates a plurality of candidate SRS carrier switching patterns, wherein a physical downlink control channel (PDCCH) downlink control information (DCI) or a medium access control-control element (MAC-CE) indicates one of the plurality of candidate SRS carrier switching patterns according to the indication of the SRS carrier switching pattern.

Aspect 9: The method of any of Aspects 1-8, wherein the SRS carrier switching pattern does not require a primary cell as a pivot point for the SRS carrier switching.

Aspect 10: A method for wireless communication by a user equipment (UE), comprising: receiving an indicator for coordinating uplink (UL) transmission (TX) switching and sounding reference signal (SRS) carrier switching; switching at least one TX chain from a source carrier to a target carrier according to the indicator, wherein the source carrier is a source UL carrier or a source SRS carrier; and transmitting one or more uplink signals on the target carrier using the at least one TX chain, wherein the one or more uplink signals include one or more of an SRS or a physical uplink shared channel (PUSCH) communication.

Aspect 11: The method of Aspect 10, further comprising: transmitting capability information that indicates a capability of the UE to support UL TX switching and SRS carrier switching coordination.

Aspect 12: The method of any of Aspects 10-11, wherein switching the at least one TX chain from the source carrier and transmitting the one or more uplink signals are performed sequentially according to the indicator.

Aspect 13: The method of any of Aspects 10-12, wherein switching the at least one TX chain from the source carrier includes: performing UL TX carrier switching in accordance with the source carrier and the target carrier both supporting UL data transmission or SRS carrier switching.

Aspect 14: The method of any of Aspects 10-13, wherein switching the at least one TX chain includes: performing SRS carrier switching in accordance with one or more of the source carrier or the target carrier having a downlink-only configuration.

Aspect 15: A method for wireless communication by a network node, comprising: transmitting, to a user equipment (UE), an indication of a sounding reference signal (SRS) carrier switching pattern; and receiving, from the UE, an SRS at a plurality of cells associated with a plurality of carriers in a sequence associated with the SRS carrier switching pattern.

Aspect 16: The method of Aspect 15, wherein the SRS carrier switching pattern is associated with one or more performance parameters for the plurality of carriers.

Aspect 17: The method of any of Aspects 15-16, further comprising: receiving, from the UE, an indication of a preferred SRS carrier switching pattern, wherein the preferred SRS carrier switching pattern is associated with one or more performance parameters for the plurality of carriers.

Aspect 18: The method of any of Aspects 15-17, further comprising: receiving, from the UE, capability information that indicates a capability of the UE to support sequential SRS carrier switching.

Aspect 19: The method of any of Aspects 15-18, further comprising: transmitting, to the UE, an indication of an updated SRS carrier switching pattern; and receiving, from the UE, an SRS at an updated plurality of cells associated with an updated plurality of carriers in an updated sequence associated with the updated SRS carrier switching pattern.

Aspect 20: The method of any of Aspects 15-19, wherein the plurality of carriers include a first carrier type and a second carrier type.

Aspect 21: The method of any of Aspects 15-20, wherein the plurality of carriers are of the same carrier type.

Aspect 22: The method of any of Aspects 15-21, further comprising: transmitting, to the UE, a radio resource control (RRC) configuration that indicates a plurality of candidate SRS carrier switching patterns, wherein a physical downlink control channel (PDCCH) downlink control information (DCI) or a medium access control-control element (MAC-CE) indicates one of the plurality of candidate SRS carrier switching patterns according to the indication of the SRS carrier switching pattern.

Aspect 23: A method of wireless communication performed by a network node, comprising: transmitting, to a user equipment (UE), an indicator for coordinating uplink (UL) transmission (TX) switching and sounding reference signal (SRS) carrier switching, wherein the indicator enables the UE to switch at least one TX chain from a source carrier, wherein the source carrier is a source UL carrier or a source SRS carrier; and receiving, from the UE, one or more uplink signals on the target carrier, wherein the one or more uplink signals include one or more of an SRS or a physical uplink shared channel (PUSCH) communication.

Aspect 24: The method of Aspect 23, further comprising: receiving, from the UE, capability information that indicates a capability of the UE to support UL TX switching and SRS carrier switching coordination.

Aspect 25: The method of any of Aspects 23-24, wherein the indicator enables the UE to perform UL switching for the at least one TX chain in accordance with the source carrier and the target carrier both supporting UL data transmission.

Aspect 26: The method of any of Aspects 23-25, wherein the indicator enables the UE to perform SRS carrier switching for the at least one TX chain in accordance with one or more of the source carrier or the target carrier having a downlink-only configuration.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive an indication of a sounding reference signal (SRS) carrier switching pattern; and
perform SRS carrier switching between a plurality of carriers, wherein performing the SRS carrier switching includes sequentially transmitting an SRS to a plurality of cells associated with the plurality of carriers according to the SRS carrier switching pattern.

2. The UE of claim 1, wherein the SRS carrier switching pattern is associated with one or more performance parameters for the plurality of carriers.

3. The UE of claim 1, the processing system further configured to cause the UE to:
transmit an indication of a preferred SRS carrier switching pattern, wherein the preferred SRS carrier switching pattern is associated with one or more performance parameters for the plurality of carriers.

4. The UE of claim 1, the processing system further configured to cause the UE to:
transmit capability information that indicates a capability of the UE to support sequential SRS carrier switching.

5. The UE of claim 1, the processing system further configured to cause the UE to:
receive an indication of an updated SRS carrier switching pattern; and
perform SRS carrier switching between an updated plurality of carriers, wherein performing the SRS carrier switching includes sequentially transmitting an SRS to an updated plurality of cells associated with the updated plurality of carriers according to the updated SRS carrier switching pattern.

6. The UE of claim 1, wherein the SRS carrier switching is performed between a first carrier type and a second carrier type.

7. The UE of claim 1, wherein the SRS carrier switching is performed between carriers of the same type.

8. The UE of claim 1, the processing system further configured to cause the UE to:
receive a radio resource control (RRC) configuration that indicates a plurality of candidate SRS carrier switching patterns, wherein a physical downlink control channel (PDCCH) downlink control information (DCI) or a medium access control-control element (MAC-CE) indicates one of the plurality of candidate SRS carrier switching patterns according to the indication of the SRS carrier switching pattern.

9. The UE of claim 1, wherein the SRS carrier switching pattern does not require a primary cell as a pivot point for the SRS carrier switching.

10. A user equipment (UE) for wireless communication, comprising:
a processing system that includes one or more processors and one or more memories coupled with the one or more processors, the processing system configured to cause the UE to:
receive an indicator for coordinating uplink (UL) transmission (TX) switching and sounding reference signal (SRS) carrier switching;
switch at least one TX chain from a source carrier to a target carrier according to the indicator, wherein the source carrier is a source UL carrier or a source SRS carrier; and
transmit one or more uplink signals on the target carrier using the at least one TX chain, wherein the one or more uplink signals include one or more of an SRS or a physical uplink shared channel (PUSCH) communication.

11. The UE of claim 10, the processing system further configured to cause the UE to:
transmit capability information that indicates a capability of the UE to support UL TX switching and SRS carrier switching coordination.

12. The UE of claim 10, wherein switching the at least one TX chain from the source carrier and transmitting the one or more uplink signals are performed sequentially according to the indicator.

13. The UE of claim 10, wherein to switch the at least one TX chain from the source carrier, the processing system is further configured to:
perform UL TX carrier switching in accordance with the source carrier and the target carrier both supporting UL data transmission or SRS carrier switching.

14. The UE of claim 10, wherein to switch the at least one TX chain from the source carrier, the processing system is further configured to:
perform SRS carrier switching in accordance with one or more of the source carrier or the target carrier having a downlink-only configuration.

15. A network node for wireless communication, comprising:
a processing system that includes one or more processors and one or more memories coupled with the one or more processors, the processing system configured to cause the network node to:
transmit, to a user equipment (UE), an indication of a sounding reference signal (SRS) carrier switching pattern; and
receive, from the UE, an SRS at a plurality of cells associated with a plurality of carriers in a sequence associated with the SRS carrier switching pattern.

16. The network node of claim 15, wherein the SRS carrier switching pattern is associated with one or more performance parameters for the plurality of carriers.

17. The network node of claim 15, the processing system further configured to cause the network node to:
receive, from the UE, an indication of a preferred SRS carrier switching pattern, wherein the preferred SRS carrier switching pattern is associated with one or more performance parameters for the plurality of carriers.

18. The network node of claim 15, the processing system further configured to cause the network node to:
receive, from the UE, capability information that indicates a capability of the UE to support sequential SRS carrier switching.

19. The network node of claim 15, the processing system further configured to cause the network node to:
transmit, to the UE, an indication of an updated SRS carrier switching pattern; and
receive, from the UE, an SRS at an updated plurality of cells associated with an updated plurality of carriers in an updated sequence associated with the updated SRS carrier switching pattern.

20. The network node of claim 15, wherein the plurality of carriers include a first carrier type and a second carrier type.
